(19) United States
(12) Patent Application Publication
(10) Pub. No.: US 2026/0006222 A1
(43) Pub. Date: Jan. 1, 2026

(54) PARALLEL MACROBLOCK SCAN LINE DECODING WITH ERROR HANDLING

(71) Applicant: Intel Corporation, Santa Clara, CA (US)

(72) Inventors: Hiu-Fai Ricky Chan, Rancho Cordova, CA (US); James Michael Holland, Folsom, CA (US); Tsung-Han Yang, Folsom, CA (US); Jason Paul Neilson, Folsom, CA (US); Nekhil Baid, Folsom, CA (US); Ce Wang, Bellevue, WA (US); Samuel Wong, San Jose, CA (US)

(73) Assignee: Intel Corporation, Santa Clara, CA (US)

(21) Appl. No.: 19/094,563

(22) Filed: Mar. 28, 2025

Related U.S. Application Data
(60) Provisional application No. 63/664,966, filed on Jun. 27, 2024.

(51) Int. Cl. H04N 19/176; H04N 19/124; H04N 19/129; H04N 19/13; H04N 19/174; H04N 19/436; H04N 19/60; H04N 19/65; H04N 19/70

(52) U.S. Cl. CPC H04N 19/176; H04N 19/124; H04N 19/129; H04N 19/13; H04N 19/174; H04N 19/436; H04N 19/60; H04N 19/65; H04N 19/70

(57) ABSTRACT

Systems, apparatus, articles of manufacture, and methods to perform parallel macroblock scan line decoding with error handling are disclosed. An example apparatus disclosed herein includes a first decoder circuit to decode a first macroblock scan line of an encoded video frame, the first decoder circuit to fetch the first macroblock scan line from memory based on a load balancing algorithm. The disclosed example apparatus also includes a second decoder circuit to decode a second macroblock scan line of the encoded video frame, the second macroblock scan line different from the first macroblock scan line, the second decoder circuit to fetch the second macroblock scan line from the memory based on the load balancing algorithm. In the disclosed example apparatus, the first decoder circuit is to decode the first macroblock scan line and the second decoder circuit is to decode the second macroblock scan line in parallel.

### RELATED APPLICATION(S)

This patent claims the benefit of U.S. Provisional Patent Application No. 63/664,966, which was filed on Jun. 27, 2024. U.S. Provisional Patent Application No. 63/664,966 is hereby incorporated herein by reference in its entirety. Priority to U.S. Provisional Patent Application No. 63/664,966 is hereby claimed.

### BACKGROUND

VC-3 codecs are video codecs that encode video based on an intra-frame compression format. VC-3 codecs support both constant bitrate (CBR) and variable (VBR) bitrate operations. Also, VC-3 coding scan be used as an intermediate format suitable for editing video and/or as a presentation format for presenting video on a display device.

In VC-3 encoding, the active video raster is subdivided into macroblocks, which are 16×16 blocks of spatially adjacent samples (e.g., pixels). Also, in VC-3 encoding, a macroblock scan line is a row of macroblocks that runs the width of the video raster.

### BRIEF DESCRIPTION OF THE DRAWINGS

FIG. 1 illustrates an example macroblock scan line structure used to encode a video frame.

FIG. 2 illustrates an example video decoding algorithm used to decode a video frame encoded based on the macroblock scan line structure of FIG. 1.

FIG. 3 is a block diagram of an example video decoder circuit that implements parallel macroblock scan line decoding with error handling in accordance with teachings of this disclosure.

FIG. 4 is a block diagram of an example implementation of the video decoder circuit of FIG. 3 that is based on the video decoding algorithm of FIG. 2.

FIG. 5 is a block diagram of an example implementation of an example entropy decoder circuit included in the video decoder circuit of FIG. 4.

FIGS. 6-7 illustrate an example macroblock structure that includes multiple coefficient blocks.

FIG. 8 illustrates an example coefficient block decoder algorithm implemented by the entropy decoder circuit of FIG. 5 to decode a coefficient block of FIGS. 6-7.

FIGS. 9-10 illustrate example error handling algorithms capable of being implemented by the entropy decoder circuit of FIG. 5 to handle errors that may occur during operation of the coefficient block decoder algorithm of FIG. 8 to decode the macroblock structure of FIGS. 6-7.

FIGS. 11-12 are flowcharts representative of example machine-readable instructions and/or example operations that may be executed, instantiated, and/or performed by example programmable circuitry to implement the video decoder circuit of FIGS. 3-10.

FIG. 13 is a block diagram of an example processing platform including programmable circuitry structured to execute, instantiate, and/or perform the example machine-readable instructions and/or perform the example operations of FIGS. 11-12 to implement the video decoder circuit of FIGS. 3-10.

FIG. 14 is a block diagram of an example implementation of the programmable circuitry of FIG. 13.

FIG. 15 is a block diagram of another example implementation of the programmable circuitry of FIG. 13.

FIG. 16 is a block diagram of an example software/firmware/instructions distribution platform (e.g., one or more servers) to distribute software, instructions, and/or firmware (e.g., corresponding to the example machine-readable instructions of FIGS. 11-12) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

As noted above, VC-3 video coding is an intra-frame compression format in which the active video raster or, in other words, the video frame being encoded, is subdivided into macroblocks, which are 16×16 blocks of spatially adjacent samples (e.g., pixels). Also, in VC-3 encoding, a row of macroblocks that runs the width of the video frame is referred to as a macroblock scan line. One property of VC-3 coding is that the encoded bitstream associated with each macroblock scan line of an encoded video frame can be decoded independently without information from other macroblock scan lines of the encoded video frame. In other words, different macroblock scan lines of an encoded video frame can be decoded independently of each other.

Example video decoder systems, apparatus, articles of manufacture, and methods disclosed herein exploit the decoding independence of each macroblock scan line in a VC-3 encoded video frame to improve the decoding bit rate and/or usage of memory bandwidth. The VC-3 encoding format is described in SMPTE Standard ST 2019-1:2016, “VC-3 Picture Compression and Data Stream Format,” 2016. As disclosed in further detail below, example video decoders disclosed herein include multiple macroblock scan line decoder circuits (also referred to as macroblock scan line decoders) to perform parallel macroblock scan line decoding. For example, the multiple macroblock scan line decoders operate in parallel to fetch and decode multiple different scan lines of an encoded video frame concurrently, thereby improving the rate at which VC-3 video frames can be decoded. Furthermore, example video decoders disclosed herein are scalable because the number of macroblock scan line decoders included in the video decoder can be increased or decreased as appropriate to meet a target frame decode time and, thus, a target decoder bit rate.

Furthermore, some example video decoders disclosed herein implement error handling to permit video decoding to continue in the face of one or more different types of decoding errors. Such error handling prevents the video decoder from freezing, crashing and/or dropping frames due to decoding errors. Such error handling may additionally or alternatively protect against malicious actors that intentionally craft or corrupt video bitstreams to produce errors that cause unintended operation of the video coder, which may provide improper access to the underlying compute system.

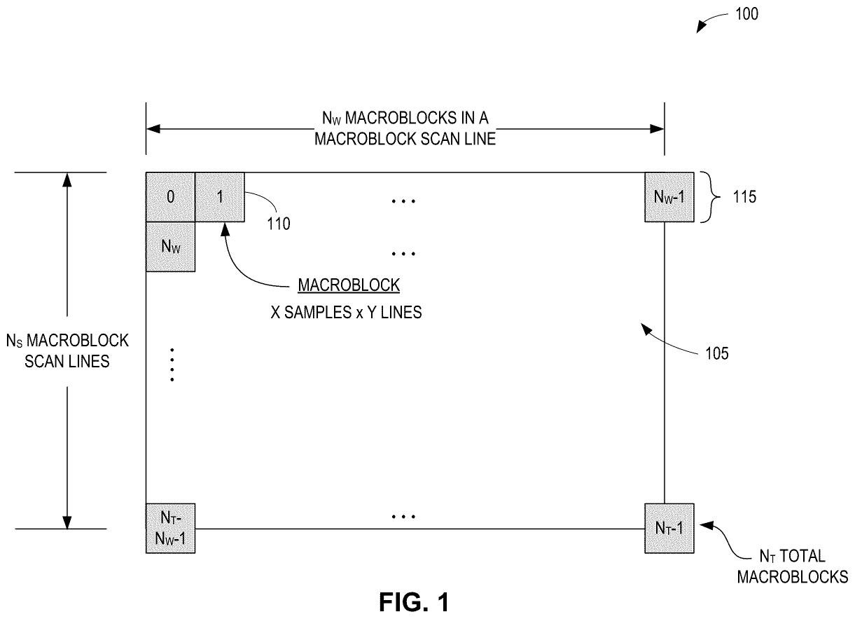

To provide further context for the description of the example video decoders disclosed herein, FIG. 1 illustrates an example macroblock scan line structure 100 used to encode a video frame based in a VC-3 encoding format. As shown in FIG. 1, an active video raster corresponding to an example video frame 105 to be encoded is subdivided into example macroblocks 110. In some examples, the macroblocks 110 are 16×16 blocks of spatially adjacent samples (e.g., pixels). Furthermore, the macroblock scan line structure 100 includes a set of example macroblock scan lines 115. In the illustrated example, a given macroblock scan line 115 is a row of macroblocks that spans, or runs, the entire width of the video raster of the video frame 105 to be encoded. Thus, in the macroblock scan line structure 100, the total number of macroblock scan lines 115 associated with the video frame 105 is represented by N_{S}, the total number of macroblocks 110 in a given macroblock scan line 115 is represented by N_{W}, and the total number of macroblocks 110 in the video frame is represented by N_{T}=N_{S}×N_{W}. For example, N_{S} can have values of 45, 68, etc., for the total number of macroblock scan lines 115 in the video frame 105, N_{W} can have values of 60, 80, 90, 120, etc., for the total number of macroblocks 110 in a given macroblock scan line 115, and N_{T} can have values of 2700, 3600, 6120, 8160, etc., for the total number of macroblocks 110 in the video frame 105.

In some examples, after the video frame 105 is VC-3 encoded based on the macroblock scan line structure 100, the resulting encoded data, also referred to as compressed data, associated with each macroblock scan line 115 of the video frame 105 includes compressed macroblock data (CMBD) and macroblock scan line padding. In some examples, the starting address of each compressed macroblock scan line (MBSL) is a multiple of 4 bytes. In some examples, the compressed macroblock data associated with the first macroblock 110 of a given macroblock scan line 115 is located after a macroblock scan indices payload area, and then is followed by the compressed data of successive macroblocks of the given macroblock scan line 115.

In some examples, the macroblock scan indices payload area includes a set of indices, with one index for each macroblock scan line 115. In some examples, the value of a given index includes the starting byte offset of the CMBD for the first macroblock 110 in the given macroblock scan line 115. In some examples, the index offset value is relative to the start of the compressed payload.

In some examples, the macroblock scan indices payload area is located at byte offset 0×170 upwards. In some examples, the locations include four-byte macroblock scan indices. In some examples, the indices are placed in this area in big-endian order, starting with the first macroblock scan line through the last macroblock scan line. In some examples, interlaced video format and/or progressive video formats below 1080p do not utilize the full area because they have fewer macroblock scan lines than 1080p video formats. In some such examples, the remaining bytes of the data area are padded with 0's or some other padding value (e.g., even in the case of variable bitrate encoding). Thus, in some examples, at the end of a given macroblock scan line 115 (e.g., after N_{W} compressed macroblock data sections for video encoding without alpha values, or after 2N_{W} compressed macroblock data sections for video and alpha value encoding) a section of macroblock scan-line padding is added to the video frame 105. Such padding ensures that the start of the next compressed macroblock scan line 115 occurs on a four-byte alignment boundary.

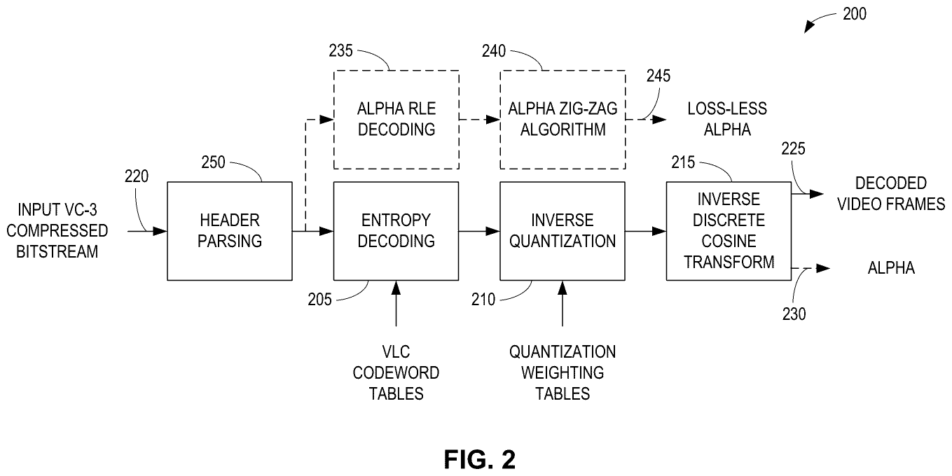

FIG. 2 illustrates an example video decoding algorithm 200 that can be used to decode a video frame that is encoded based on the example macroblock scan line structure 100 of FIG. 1. The example video decoding algorithm 200 corresponds to an example VC-3 decoding algorithm that is compliant with SMPTE Standard ST 2019-1:2016, “VC-3 Picture Compression and Data Stream Format,” 2016. As described above, one property of VC-3 coding is that the encoded bitstream associated with each macroblock scan line 115 of an encoded video frame 105 can be decoded independently without information from other macroblock scan lines 115 of the encoded video frame 105. In other words, different macroblock scan lines 115 of an encoded video frame 105 can be decoded independently of each other. The video decoding algorithm 200 takes advantage of this property.

For example, the video decoding algorithm 200 includes an example entropy decoding algorithm 205, an example inverse quantization algorithm 210 and an example inverse transformation algorithm 215 that can be performed on each encoded macroblock scan line of an encoded video frame. In the illustrated example of FIG. 2, the entropy decoding algorithm 205 operates on encoded data of an example input VC-3 compressed bitstream 220 to produce output quantized transform coefficients, such as quantized discrete cosine transform (DCT) coefficients, corresponding to the encoded macroblocks of a given encoded macroblock scan line being decoded. In the illustrated example of FIG. 2, the inverse transformation algorithm 215 performs an inverse transform, such as an inverse DCT transform, on the unquantized transform coefficients output from the inverse quantization algorithm 210 to the decoded pixels of the output, decoded video frames 225 produced by the video decoding algorithm 200.

The example video decoding algorithm 200 also supports decoding of alpha values if they are present in the encoded bitstream 220. An alpha value specifies the transparency, or opacity, of a corresponding pixel of a decoded video frame 225. In some examples, the alpha values, if present, are encoded using lossy compression similar to the compression used to encode the pixels. Thus, in some examples, the video decoding algorithm 200 re-uses the entropy decoding algorithm 205, the inverse quantization algorithm 210 and the inverse transformation algorithm 215 to decode example alpha values 230 corresponding to the decoded pixels included in the output decoded video frames 225.

In some examples, the alpha values, if present, are encoded using lossless compression. Thus, in some examples, the video decoding algorithm 200 includes an example alpha run length encoding (RLE) decoding algorithm 235 and an example alpha zig-zag algorithm 240. In the illustrated example of FIG. 2, the alpha RLE decoding algorithm 235 converts the compressed alpha values in the input VC-3 compressed bitstream 220 into decompressed alpha values. In the illustrated example of FIG. 2, the alpha zig-zag algorithm 240 rearranges the decompressed alpha values based on a zig-zag pattern to produce example output lossless alpha values 245.

The example video decoding algorithm 200 of FIG. 2 also includes an example header parsing algorithm 250 to parse header information included in the input compressed bitstream 220. For example, the header information parsed produced by the header parsing algorithm 250 may specify parameters of the encoded video frames, such as the number of macroblock scan lines 115 in the encoded video frame (e.g., the value of N_{S}), the number of macroblocks 110 included in each macroblock scan line (e.g., the value of N_{W}), the size of the input compressed bitstream 220 (e.g., which may include the size of each encoded macroblock scan line of a given encoded video frame), etc.

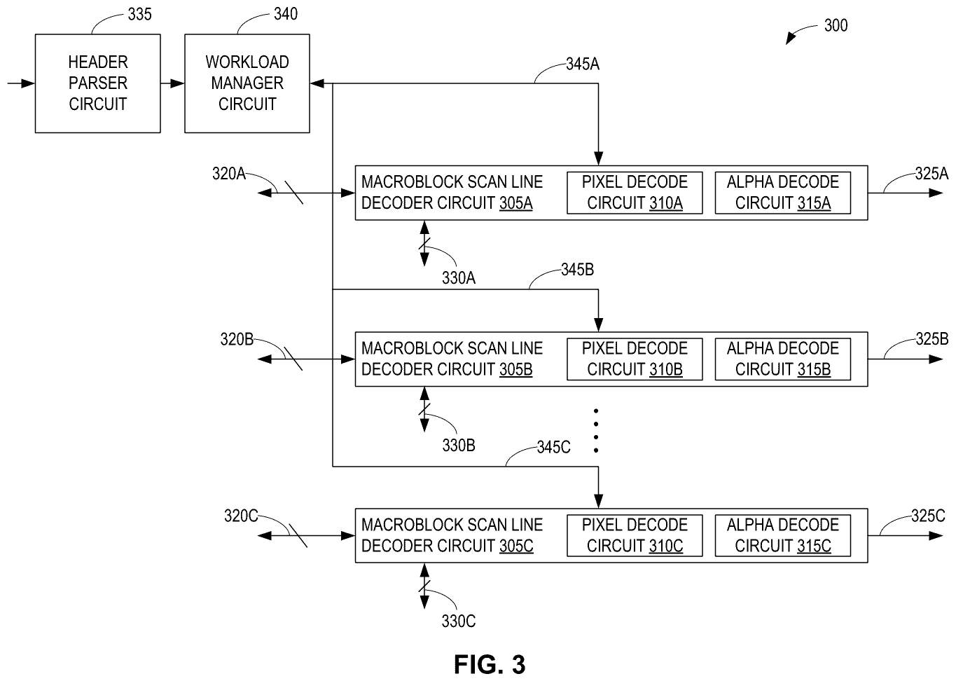

FIG. 3 is a block diagram of an example video decoder circuit 300 that implements parallel macroblock scan line decoding with error handling in accordance with teachings of this disclosure. The video decoder circuit 300 of FIG. 3 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the video decoder circuit 300 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

The example video decoder circuit 300 of FIG. 3 exploits the decoding independence of each macroblock scan line 115 in a VC-3 encoded video frame 105 to improve the decoding bit rate and/or usage of memory bandwidth. In the illustrated example, the video decoder circuit 300 includes multiple example macroblock scan line decoder circuits 305A-C (also referred to as example macroblock scan line decoders 305A-C) to perform parallel macroblock scan line decoding. For example, the multiple macroblock scan line decoder circuits 305A-C operate in parallel to fetch and decode multiple different macroblock scan lines 115 of an encoded video frame 105 concurrently, thereby improving the rate at which VC-3 video frames can be decoded.

In the illustrated example, the macroblock scan line decoder circuits 305A-C implement respective instances of the example video decoding algorithm 200 of FIG. 2. As such, the macroblock scan line decoder circuits 305A-C include respective example pixel decode circuits 310A-C and respective example alpha decode circuits 315A-C. In the illustrated example, the pixel decode circuits 310A-C implement respective instances of the entropy decoding algorithm 205, the inverse quantization algorithm 210 the example inverse transformation algorithm 215 to decode a given encoded macroblock scan line to obtain the decoded macroblocks of that macroblock scan line, which include the pixels of decoded video frame that make up the decoded macroblocks. In the illustrated example, the alpha decode circuits 315A-C implement respective instances of the alpha RLE decoding algorithm 235 and the alpha zig-zag algorithm 240 to decode a given encoded macroblock scan line to obtain the decoded alpha values corresponding to the decoded macroblocks of that macroblock scan line.

In the illustrated example video decoder circuit 300 of FIG. 3, the multiple macroblock scan line decoder circuits 305A-C operate in parallel to fetch and decode multiple different macroblock scan lines 115 of an encoded video frame 105 concurrently based on a load balancing algorithm. For example, the macroblock scan line decoder circuit 305A may fetch and decode a first macroblock scan line of an encoded video frame, and the macroblock scan line decoder circuit 305B may fetch and decode a second macroblock scan line of the encoded video frame, with the second macroblock scan line being different from the first macroblock scan line. Furthermore, the macroblock scan line decoder circuit 305A may select the first macroblock scan line of the encoded video frame based on the load balancing algorithm, and the macroblock scan line decoder circuit 305B may select the second macroblock scan line of the encoded video frame based on the load balancing algorithm such that the macroblock scan line decoder circuits 305A and 305B can decode the first and second macroblock scan lines in parallel (e.g., concurrently).

As such, the macroblock scan line decoder circuits 305A-C include respective example input interfaces 320A-C to fetch data associated with the respective macroblock scan lines to be decoded by the macroblock scan line decoder circuits 305A-C. For example, the input interfaces 320A-C may access one or more memories that store the compressed video bitstream to be decoded by the video decoder circuit 300. Likewise, the macroblock scan line decoder circuits 305A-C include respective example output interfaces 325A-C to output the decoded macroblock pixel and alpha data associated with the respective macroblock scan lines to be decoded by the macroblock scan line decoder circuits 305A-C. For example, the output interfaces 325A-C may access one or more memories that store the decoded output of the video decoder circuit 300. Furthermore, the macroblock scan line decoder circuits 305A-C include respective example load balancing interfaces 330A-C to configure the load balancing algorithm to be utilized (e.g., implemented) by the macroblock scan line decoder circuits 305A-C.

In some examples, the macroblock scan line decoder circuits 305A-C implement a cyclical load balancing algorithm, also referred to as a round-robin load balancing algorithm. In some such examples, the load balancing interfaces 330A-C include first inputs that specify a total number of macroblock scan line decoder circuits 305A-C in the video decoder circuit 300, which corresponds to the number of macroblock scan lines 115 to be decoded in parallel. In some such examples, the load balancing interfaces 330A-C include second inputs that specify modulo values assigned to the respective macroblock scan line decoder circuits 305A-C. As such, the first inputs of the load balancing interfaces 330A-C specify the depth, or period, of the round-robin load balancing algorithm, and the second inputs of the load balancing interfaces 330A-C specify the modulo offset used by the macroblock scan line decoder circuits 305A-C to select and fetch different ones of the macroblock scan lines 115 in parallel.

For example, the macroblock scan line decoder circuit 305A may include a first input and a second input in its load balancing interface 330A. In such an example, the first input of the load balancing interface 330A of the macroblock scan line decoder circuit 305A may specify a number of macroblock scan lines to be decoded in parallel (e.g., 3 in the illustrated example), and the second input the load balancing interface 330A of the macroblock scan line decoder circuit 305A may specify a first modulo value relative to the value of the first input (e.g., a value of 0 in the illustrated example). The macroblock scan line decoder circuit 305A then uses the first modulo value (e.g., 0) as an initial offset and the number of macroblock scan lines to be decoded in parallel (e.g., 3) as an increment depth or period for configuring selection of successive ones of the macroblock scan lines to be fetched by the macroblock scan line decoder circuit 305A for decoding. For example, the macroblock scan line decoder circuit 305A may select and fetch the macroblock scan lines with indices 0, 3, 6, 9, etc., based on a value of 3 at the first input of the load balancing interface 330A and the value of 0 at the second input of the load balancing interface 330A.

Continuing with the round-robin load balancing example, the macroblock scan line decoder circuit 305B may also include a first input and a second input in its load balancing interface 330B. In such an example, the first input of the load balancing interface 330B of the macroblock scan line decoder circuit 305B may specify the number of macroblock scan lines to be decoded in parallel (e.g., 3 in the illustrated example), and the second input the load balancing interface 330B of the macroblock scan line decoder circuit 305B may specify a second modulo value relative to the value of the first input (e.g., a value of 1 in the illustrated example). The macroblock scan line decoder circuit 305B then uses the second modulo value (e.g., 1) as an initial offset and the number of macroblock scan lines to be decoded in parallel (e.g., 3) as an increment depth or period for configuring selection of successive ones of the macroblock scan lines to be fetched by the macroblock scan line decoder circuit 305B for decoding. For example, the macroblock scan line decoder circuit 305B may select and fetch the macroblock scan lines with indices 1, 4, 7, 10, etc., based on a value of 3 at the first input of the load balancing interface 330B and the value of 1 at the second input of the load balancing interface 330B. Thus, using such a round-robin load balancing algorithm, the macroblock scan line decoder circuits 305A and the macroblock scan line decoder circuit 305B are able to successively fetch different macroblock scan lines for decoding in parallel.

In some examples, the macroblock scan line decoder circuits 305A-C implement a greedy load balancing algorithm, also referred to as a first-available load balancing algorithm. In some such examples, the load balancing interfaces 330A-C enable the macroblock scan line decoder circuits 305A-C in the video decoder circuit 300 to access a data structure, such as a look-up table, that tracks the decode status of the macroblock scan lines of the encoded video frame to be decoded. For example, the data structure may have entries that include the indices of the different macroblock scan lines of the encoded video frame to be decoded. The entries of the data structure may also include values that specify the decode status of the different macroblock scan lines of the encoded video frame to be decoded. For example, the values can specify whether a given macroblock scan line is available for decoding or is unavailable for decoding (e.g., because it has already been fetched by one of the macroblock scan line decoder circuits 305A-C for decoding). In some examples, to select macroblock scan lines to be fetched for decoding, a given one of the macroblock scan line decoder circuits 305A-C accesses the data structure via its respective load balancing interface 330A-C and selects the next available macroblock scan line as the one to be fetched. In some such examples, after selecting and/or fetching the next available macroblock scan line, the given one of the macroblock scan line decoder circuits 305A-C updates the entry in the data structure for that macroblock scan line to indicate the macroblock scan line is now unavailable for decoding. Such an update prevents another of the macroblock scan line decoder circuits 305A-C from attempting to fetch and decode a macroblock scan line that has already been fetched for decoding.

For example, the macroblock scan line decoder circuit 305A may use its load balancing interface 330A to select a first macroblock scan line based on the data structure. For example, the data structure may specify the first macroblock scan line is a next available undecoded macroblock scan line of the encoded video frame. Then, the macroblock scan line decoder circuit 305A may use its load balancing interface 330A update the data structure after selection of the first macroblock scan line to specify the first macroblock scan line is unavailable for decoding.

Continuing this greedy load balancing example, the macroblock scan line decoder circuit 305B may then use its load balancing interface 330B to select a second macroblock scan line based on the data structure. For example, the data structure may specify the second macroblock scan line is a next available undecoded macroblock scan line of the encoded video frame. Then, the macroblock scan line decoder circuit 305B may use its load balancing interface 330B update the data structure after selection of the second macroblock scan line to specify the second macroblock scan line is unavailable for decoding.

The example video decoder circuit 300 of FIG. 3 also includes an example header parser circuit 335 to implement the example header parsing algorithm 250 of FIG. 2. As such, the header parser circuit 335 parses a header included in an input compressed bitstream that conveys the VC-3 encoded video frames to be decoded. For example, the header parser circuit 335 may parse the header to determine parameters of the encoded video frames conveyed by the input compressed bitstream, such as the number of macroblock scan lines 115 in the encoded video frame (e.g., the value of N_{S}), the number of macroblocks 110 included in each macroblock scan line (e.g., the value of N_{W}), the size of the input compressed bitstream 220 (e.g., which may include the size of each encoded macroblock scan line of a given encoded video frame), etc.

The example video decoder circuit 300 of FIG. 3 further includes an example workload manager circuit 340 to configure operation of the macroblock scan line decoder circuits 305A-C based on respective configuration interfaces 345A-C of the macroblock scan line decoder circuits 305A-C. In the illustrated example, the workload manager circuit 340 configures the operation of the macroblock scan line decoder circuits 305A-C based on the header included in the compressed video bitstream and associated with the encoded video frames to be decoded. For example, the workload manager circuit 340 may obtain the decoded header information from the header parser circuit 335. In some examples, the workload manager circuit 340 may configure, based on the header, the macroblock scan line decoder circuit 305A with a size of a bitstream associated with an encoded video frame to be decoded, a number of macroblock scan lines in the encoded video frame, and a first number of macroblocks included in a first macroblock scan line to be decoded by the macroblock scan line decoder circuit 305A. In some such examples, the workload manager circuit 340 may also configure, based on the header, the macroblock scan line decoder circuit 305B with the size of the bitstream associated with the encoded video frame, the number of macroblock scan lines in the encoded video frame, and a second number of macroblocks included in the second macroblock scan line to be decoded by the macroblock scan line decoder circuit 305B.

The example video decoder circuit 300 of FIG. 3 depicts the video decoder circuit 300 including three macroblock scan line decoder circuits 305A-C. However, the video decoder circuit 300 is not limited thereto. On the contrary, the video decoder circuit 300 of the illustrated example is scalable because the number of the macroblock scan line decoder circuits 305A-C included in the video decoder circuit 300 can be increased or decreased as appropriate to meet a target frame decode time and, thus, a target decoder bit rate. Furthermore, although the video decoder circuit 300 has been described in the context of decoding VC-3 encoded video frames, the video decoder circuit 300 is not limited thereto. On the contrary, the video decoder circuit 300 can be adapted for use in decoding video frames that are encoded with any encoding format that has the property that scan lines (e.g., macroblock scan lines) of the encoded video frame can be decoded independently.

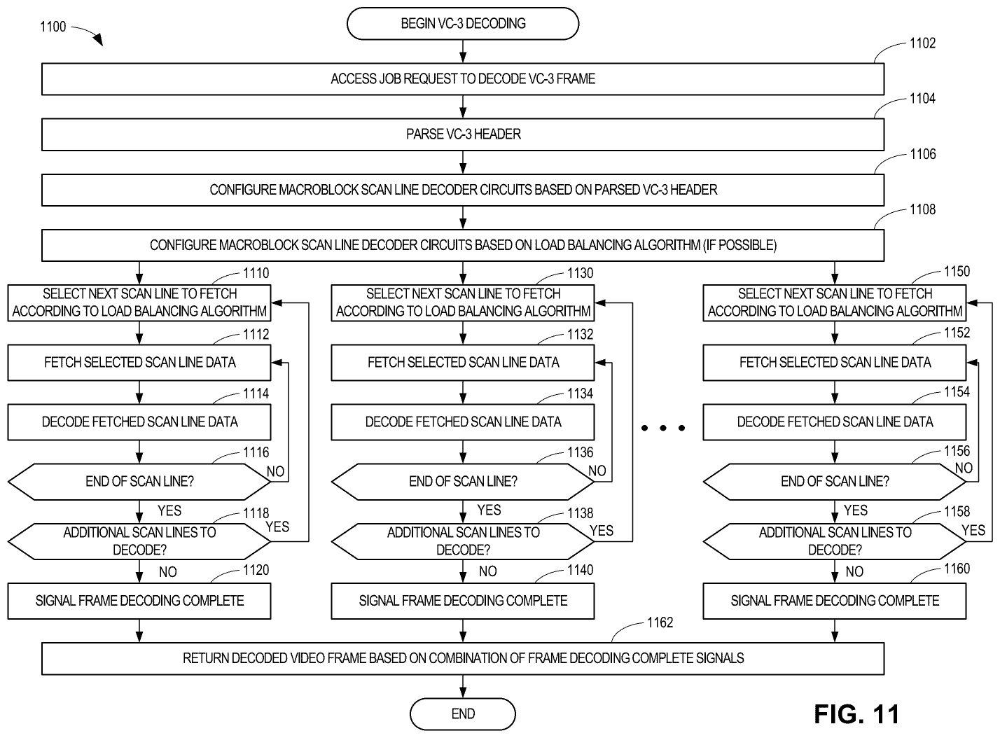

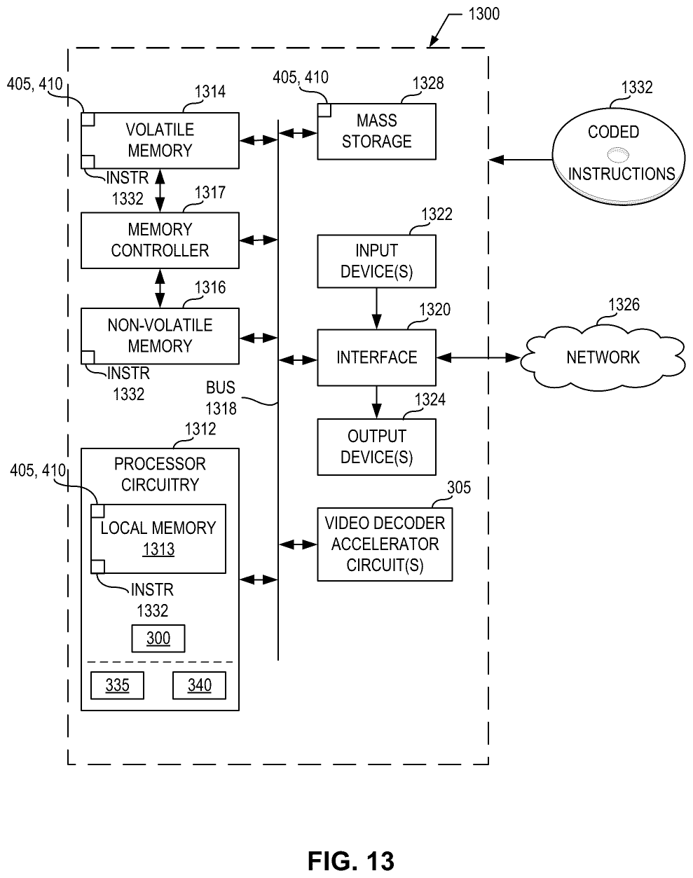

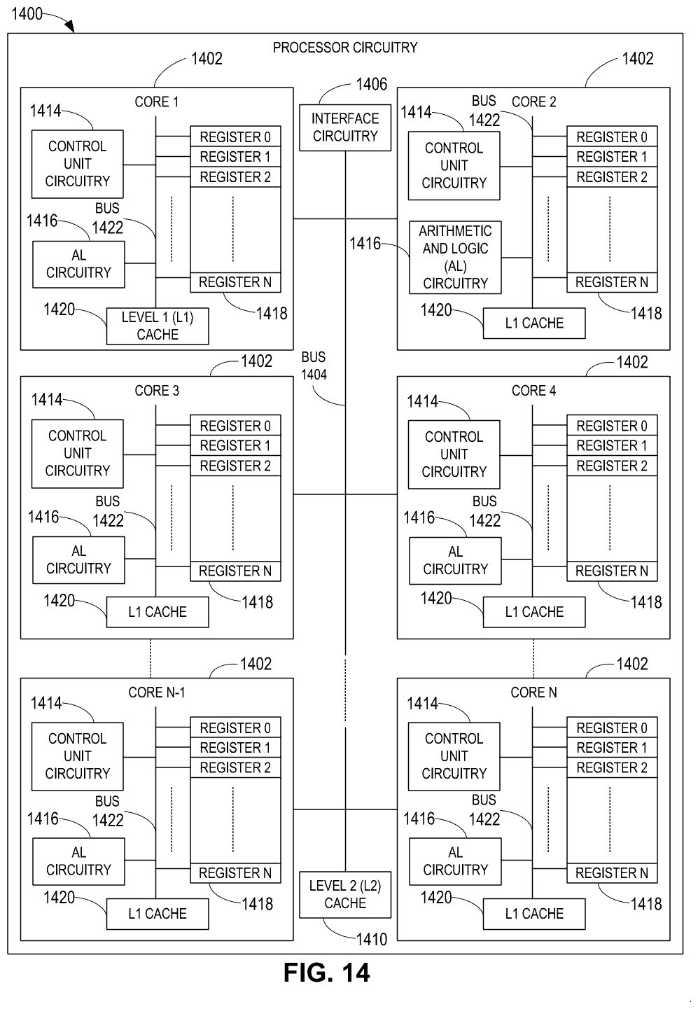

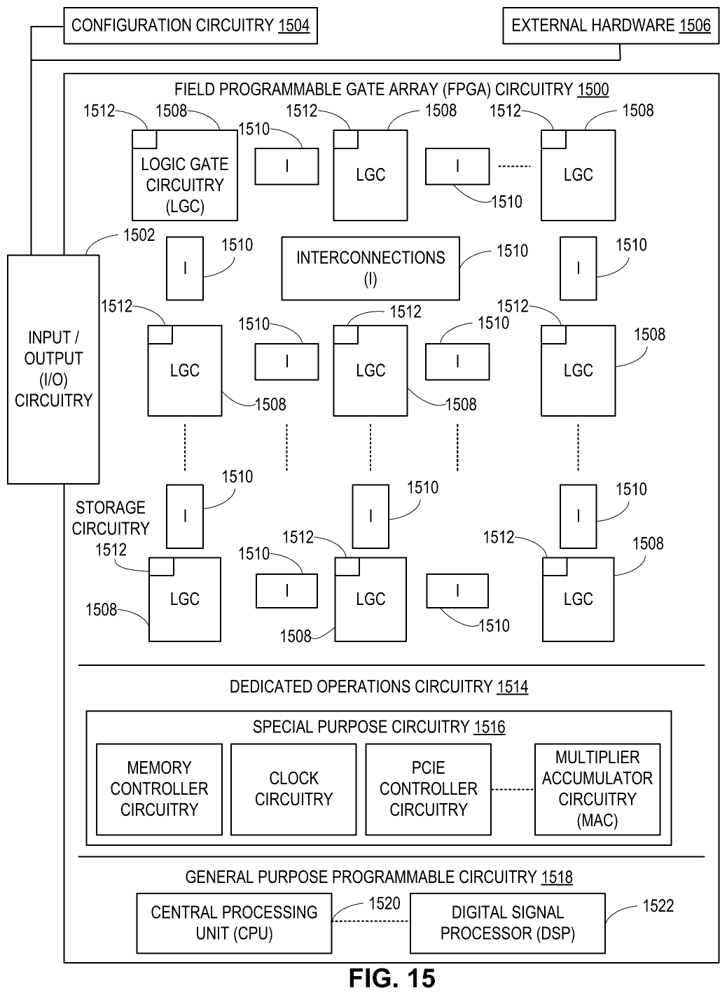

In some examples, the video decoder circuit 300 includes means for performing macroblock scan line decoding. For example, the means for performing macroblock scan line decoding may be implemented by the macroblock scan line decoder circuits 305A-C. In some examples, the macroblock scan line decoder circuits 305A-C may be instantiated by programmable circuitry such as the example programmable circuitry 1312 of FIG. 13. For instance, the macroblock scan line decoder circuits 305A-C may be instantiated by the example microprocessor 1400 of FIG. 14 executing machine executable instructions such as those implemented by at least blocks 1110-1160 of FIG. 11. In some examples, the macroblock scan line decoder circuits 305A-C may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the macroblock scan line decoder circuits 305A-C may be instantiated by any other combination of hardware, software, and/or firmware. For example, the macroblock scan line decoder circuits 305A-C may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the video decoder circuit 300 includes means for performing header parsing. For example, the means for performing header parsing may be implemented by the header parser circuit 335. In some examples, the header parser circuit 335 may be instantiated by programmable circuitry such as the example programmable circuitry 1312 of FIG. 13. For instance, the header parser circuit 335 may be instantiated by the example microprocessor 1400 of FIG. 14 executing machine executable instructions such as those implemented by at least block 1104 of FIG. 11. In some examples, the header parser circuit 335 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the header parser circuit 335 may be instantiated by any other combination of hardware, software, and/or firmware. For example, the header parser circuit 335 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the video decoder circuit 300 includes means for performing decoder workload management. For example, the means for performing decoder workload management may be implemented by the workload manager circuit 340. In some examples, the workload manager circuit 340 may be instantiated by programmable circuitry such as the example programmable circuitry 1312 of FIG. 13. For instance, the workload manager circuit 340 may be instantiated by the example microprocessor 1400 of FIG. 14 executing machine executable instructions such as those implemented by at least blocks 1102 and 1104 of FIG. 11. In some examples, the workload manager circuit 340 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the workload manager circuit 340 may be instantiated by any other combination of hardware, software, and/or firmware. For example, the workload manager circuit 340 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

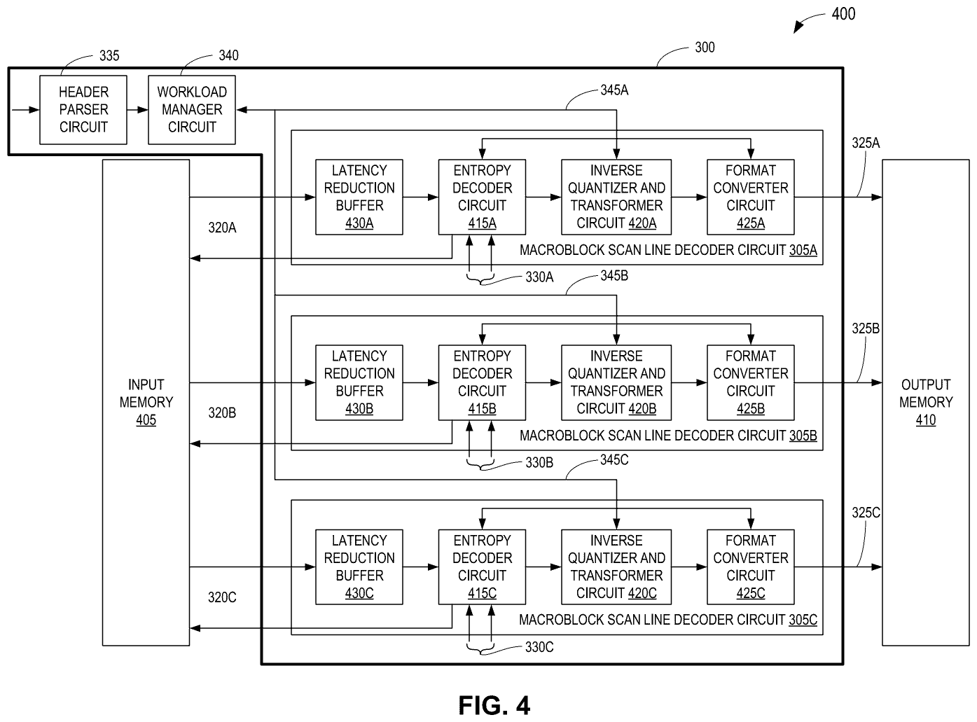

FIG. 4 is a block diagram of an example video decoding system 400 that includes an example implementation of the video decoder circuit 300 of FIG. 3. The video decoding system 400 of FIG. 4 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the video decoding system 400 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

The example video decoding system 400 of FIG. 4 includes an example implementation of the video decoder circuit 300 of FIG. 3, as well as example input memory 405 and example output memory 410. The input memory 405 and the output memory 410 can be implemented by any number(s) and/or type(s) of memories, memory device(s), storage device(s), etc. Also, the input memory 405 and the output memory 410 may be implemented as different memories or as the same memory. For example, the input memory 405 and the output memory 410 can be implemented by one or more of the volatile memory 1314, the mass storage discs or devices 1328, etc., of FIG. 13, which is described in further detail below.

The example implementation of the video decoder circuit 300 illustrated in FIG. 4 includes the macroblock scan line decoder circuits 305A-C, the header parser circuit 335 and the workload manager circuit 340 described above in the context of FIG. 3. As such, the example implementations of the macroblock scan line decoder circuits 305A-C illustrated in FIG. 4 include their respective input interfaces 320A-C, their respective output interfaces 325A-C, their respective load balancing interfaces 330A-C and their configuration interfaces 345A-C, which are described above in the context of FIG. 3.

In the illustrated example implementation of FIG. 4, the macroblock scan line decoder circuits 305A-C include respective example entropy decoder circuits 415A-C, respective example inverse quantizer and transformer circuits 420A-C, and example format converter circuits 425A-C. In the illustrated example implementation of FIG. 4, the macroblock scan line decoder circuits 305A-C also include respective example latency reduction buffers 430A-C. In some examples, the latency reduction buffers 430A-C may be included in or otherwise implemented by the entropy decoder circuits 415A-C.

In the illustrated example, the entropy decoder circuit 415A, the inverse quantizer and transformer circuit 420A, the format converter circuit 425A and the latency reduction buffer 430A implement the pixel decode circuit 310A of the macroblock scan line decoder circuit 305A described above. Likewise, the entropy decoder circuit 415B, the inverse quantizer and transformer circuit 420B, the format converter circuit 425B and the latency reduction buffer 430B implement the pixel decode circuit 310B of the macroblock scan line decoder circuit 305B described above, and the entropy decoder circuit 415C, the inverse quantizer and transformer circuit 420C, the format converter circuit 425C and the latency reduction buffer 430C implement the pixel decode circuit 310C of the macroblock scan line decoder circuit 305C described above. The example macroblock scan line decoder circuits 305A-C of FIG. 4 do not include the alpha decode circuits 315A-C described above. However, in some examples, the macroblock scan line decoder circuits 305A-C of FIG. 4 are modified to include the respective alpha decode circuits 315A-C described above.

The entropy decoder circuits 415A-C of the illustrated example implement the entropy decoding algorithm 205 described above for the respective macroblock scan line decoder circuits 305A-C. As such, the entropy decoder circuits 415A-C are responsible for performing macroblock scan line table parsing and entropy decoding in the VC-3 decoding process implemented by the respective macroblock scan line decoder circuits 305A-C. In the illustrated example, the entropy decoder circuits 415A-C select their respective compressed macroblock scan lines to be fetched and decoded based on a load balancing algorithm (e.g., a round-robin algorithm) configured by their respective load balancing interfaces 330A-C, as described above. In some examples, the entropy decoder circuits 415A-C each read the macroblock scan line indices provided by the workload manager circuit 340 to find the start of their respective compressed macroblock scan lines to be fetched and decoded. In some examples, the entropy decoder circuits 415A-C then read their respective compressed macroblock scan lines by computing read addresses based on the indices and sending memory read requests to the input memory 405 to load the respective compressed macroblock scan line data into the latency reduction buffers 430A-C. In some examples, the entropy decoder circuits 415A-C then read the fetched compressed macroblock scan line data from their respective latency reduction buffers 430A-C, perform entropy decoding on an 8×8 sample granularity (or some other granularity), and provided the decoded data to the respective inverse quantizer and transformer circuits 420A-C.

The inverse quantizer and transformer circuits 420A-C of the illustrated example implement the inverse quantization algorithm 210 and the inverse transformation algorithm 215 described above for the respective macroblock scan line decoder circuits 305A-C. As such, the inverse quantizer and transformer circuits 420A-C are responsible for performing the inverse quantization and inverse discrete cosine transformation in the VC-3 decoding process implemented by the respective macroblock scan line decoder circuits 305A-C. In some examples, the inverse quantizer and transformer circuits 420A-C perform inverse quantization on the decoded data provided by the respective entropy decoder circuits 415A-C on a 1 DCT coefficient per clock cycle basis. In some examples, the inverse quantizer and transformer circuits 420A-C then perform inverse discrete cosine transformation of the inverse quantized decoded data in the horizontal direction on a 1 DCT coefficient per clock cycle basis and store their respective results in a horizontal accumulator with an 8×8 sample granularity. In some examples, the inverse quantizer and transformer circuits 420A-C then perform inverse discrete cosine transformation of the horizontal accumulator data in the vertical direction on a 8×8 sample per 8 clock cycle basis and provide their resulting inverse transformed data to the respective format converter circuits 425A-C.

The format converter circuits 425A-C of the illustrated example are responsible for writing the final decoded video frame data output by the macroblock scan line decoder circuits 305A-C for their respective macroblock scan lines to the output memory 410. In some examples, the format converter circuits 425A-C also perform one or more format conversion operations for their respective macroblock scan line decoder circuits 305A-C. For example, the format converter circuits 425A-C may perform color space conversion (e.g., on a 4 pixels per clock basis) to convert the decoded video frame data from a YUV format to an RGB format. In some examples, the format converter circuits 425A-C may also format the decoded video frame data into cache lines, and then compute addresses at which to write the decoded video frame data from the respective macroblock scan line decoder circuits 305A-C to the output memory 410.

In the illustrated example implementation of FIG. 4, the header parser circuit 335 implements the header parsing algorithm 250 described above. In the illustrated example implementation of FIG. 4, workload manager circuit 340 provides the parsed header information to the macroblock scan line decoder circuits 305A-C, as described above. Thus, the workload manager circuit 340 is able to configure the entropy decoder circuits 415A-C, the inverse quantizer and transformer circuits 420A-C and the format converter circuits 425A-C of the respective macroblock scan line decoder circuits 305A-C based on the parsed header information. In some examples, the header parser circuit 335 and/or the workload manager circuit 340 may be implemented by software and/or firmware executed by one or more programmable circuits, such as the programmable circuitry 1312 of the programmable circuitry platform 1300 described in detail below.

In some examples, the video decoder circuit 300 includes means for performing entropy decoding. For example, the means for performing entropy decoding may be implemented by the entropy decoder circuits 415A-C. In some examples, the entropy decoder circuits 415A-C may be instantiated by programmable circuitry such as the example programmable circuitry 1312 of FIG. 13. For instance, the entropy decoder circuits 415A-C may be instantiated by the example microprocessor 1400 of FIG. 14 executing machine executable instructions such as those implemented by at least blocks 1110-1160 of FIG. 11. In some examples, the entropy decoder circuits 415A-C may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the entropy decoder circuits 415A-C may be instantiated by any other combination of hardware, software, and/or firmware. For example, the entropy decoder circuits 415A-C may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the video decoder circuit 300 includes means for performing inverse quantizing and transforming. For example, the means for performing inverse quantizing and transforming may be implemented by the inverse quantizer and transformer circuits 420A-C. In some examples, the inverse quantizer and transformer circuits 420A-C may be instantiated by programmable circuitry such as the example programmable circuitry 1312 of FIG. 13. For instance, the inverse quantizer and transformer circuits 420A-C may be instantiated by the example microprocessor 1400 of FIG. 14 executing machine executable instructions such as those implemented by at least blocks 1114, 1124 and 1154 of FIG. 11. In some examples, the inverse quantizer and transformer circuits 420A-C may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the inverse quantizer and transformer circuits 420A-C may be instantiated by any other combination of hardware, software, and/or firmware. For example, the inverse quantizer and transformer circuits 420A-C may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the video decoder circuit 300 includes means for performing format conversion. For example, the means for performing format conversion may be implemented by the format converter circuits 425A-C. In some examples, the format converter circuits 425A-C may be instantiated by programmable circuitry such as the example programmable circuitry 1312 of FIG. 13. For instance, the format converter circuits 425A-C may be instantiated by the example microprocessor 1400 of FIG. 14 executing machine executable instructions such as those implemented by at least blocks 1114, 1124 and 1154 of FIG. 11. In some examples, the format converter circuits 425A-C may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the format converter circuits 425A-C may be instantiated by any other combination of hardware, software, and/or firmware. For example, the format converter circuits 425A-C may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

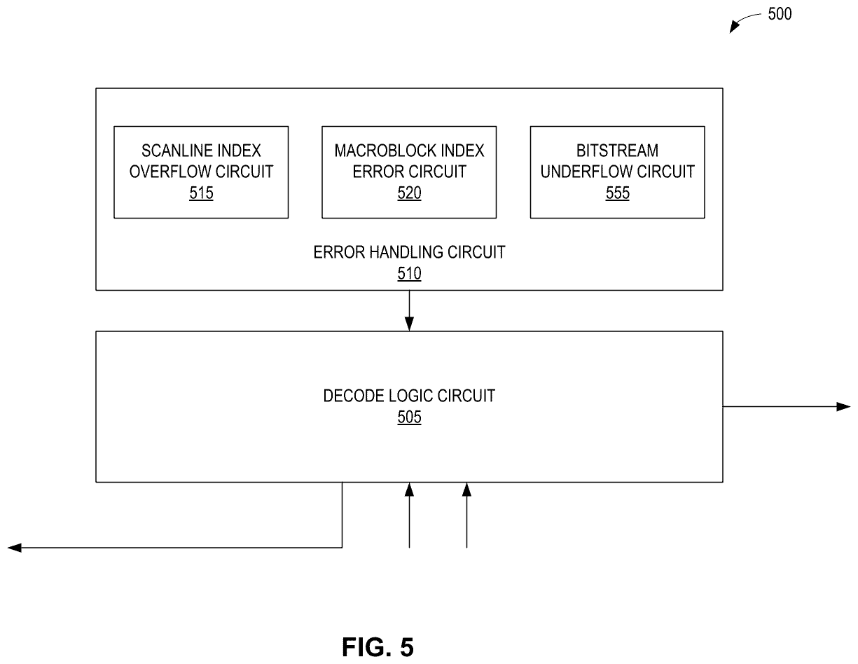

FIG. 5 is a block diagram of an example implementation of an example entropy decoder circuit 500 that can be used to implement the respective entropy decoder circuits 415A-C included in the video decoder circuit 300 of FIG. 4. The entropy decoder circuit 500 of FIG. 5 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the entropy decoder circuit 500 of FIG. 5 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 5 may, thus, be instantiated at the same or different times. Some or all of the circuitry of FIG. 5 may be instantiated, for example, in one or more threads executing concurrently on hardware and/or in series on hardware. Moreover, in some examples, some or all of the circuitry of FIG. 5 may be implemented by microprocessor circuitry executing instructions and/or FPGA circuitry performing operations to implement one or more virtual machines and/or containers.

The entropy decoder circuit 500 includes an example decode logic circuit 505 to implement the entropy decoding algorithm 205 described above. The entropy decoder circuit 500 also includes an example error handling circuit 510 to implement error handing to enable the entropy decoder circuit 500 and, more generally, the video decoder circuit 300 to continue decoding video in the face of one or more different types of decoding errors. For example, when bitstreams are transmitted over the Internet, they may become vulnerable to corruption that can undermine data integrity. Also, malicious actors may intentionally craft illegal bitstreams as a way to bypass the video decoding system and gain access to critical aspects of the infrastructure. Such unauthorized activities not only jeopardize the security of the system but can also lead to a complete cessation of the video decoding process, resulting in a system freeze. In some examples, a system reset may be required to resolve the problem, which can detract from the overall user experience.

The error handling circuit 510 can prevent the video decoder circuit 300 from dropping video frames due to a corrupted bitstream to improve the user experience. For example, the error handling circuit 510 includes an example scanline index overflow circuit 515 to handle scanline index overflow errors, an example macroblock index error circuit 520 to handle macroblock index errors, and an example bitstream underflow circuit 525 to handle bitstream underflow errors. Operation of the index overflow circuit 515, the macroblock index error circuit 520 and the bitstream underflow circuit 525 in the error handling circuit 510 is described in detail below.

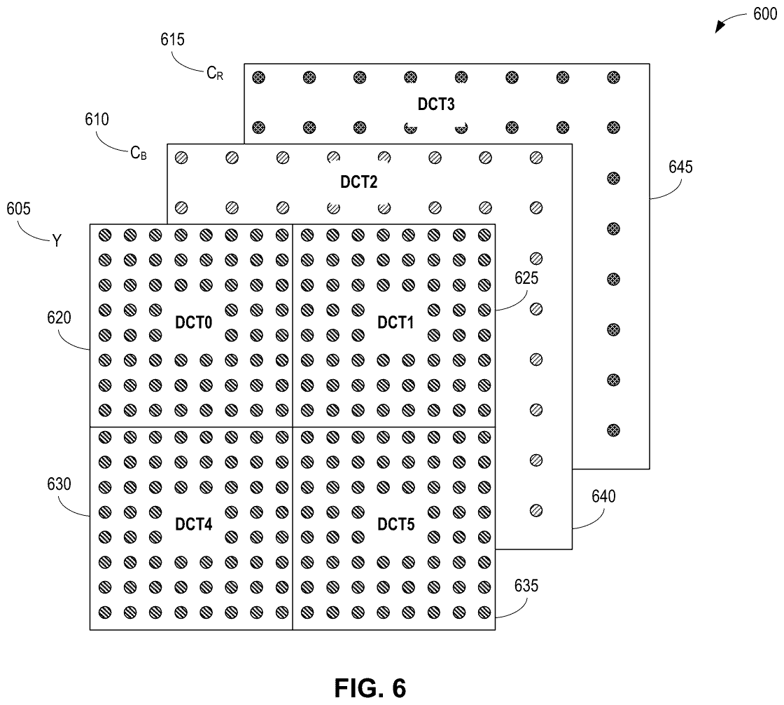

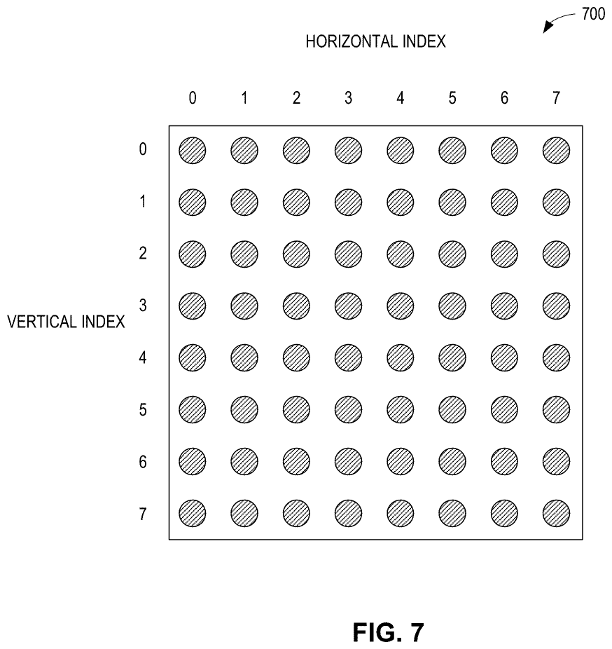

To provide further context for the description of the example error handling circuit 510, FIGS. 6-7 illustrate an example macroblock structure 600 that includes multiple example coefficient blocks, The macroblock structure 600 corresponds to 4:2:0 chroma subsampling. In the illustrated example, the macroblock structure 600 includes a luminance, or luma, component 605 (labeled “Y” in the FIG. 6) and two chrominance, or chroma, components 610 and 615 (labeled “C_{B}” and “C_{R}” in FIG. 6). In the macroblock structure 600, the 64×64 samples of the luma component 605 are subdivided into four (4) coefficient blocks 620-635, also referred to as DCT blocks 620-635, each containing 8×8 samples corresponding to 8 pixels×8 lines, as shown. In the macroblock structure 600, the two chroma components 610 and 615 include respective coefficient blocks 640-645, also referred to as DCT blocks 640-645, each containing 8×8 samples corresponding to 16 pixels×16 lines due to the chroma subsampling, as shown. The term “samples” in this context refers to pixels in the unencoded domain, and coefficients (e.g., DCT coefficients) in the coded domain.

FIG. 7 further illustrates the structure of an individual coefficient block 700, also referred to as a DCT block 700, which may correspond to any of the coefficient blocks 620-645 of FIG. 6. The coefficient block 700 is an 8×8 block of video samples, represented by x(i, j), where the index i and line index j range from 0 to 7. Thus, a coefficient, x(i, j), has a block index given by blockindex=i+j*8.

Returning to FIG. 5, the index overflow circuit 515 handles macroblock scan line index overflow errors that may occur when the entropy decoder circuit 500 reads data for an encoded macroblock scan line from the input memory 405. For example, the decode logic circuit 505 of the entropy decoder circuit 500 may perform data fetches associated with a given macroblock scan line based on a fetch index. A macroblock scan line index overflow error occurs when the fetch index exceeds the size of the video bitstream associated with the encoded video frame being decoded. In some examples, the size of the video bitstream is signaled in the packet header that is parsed by the header parser circuit 335. A macroblock scan line index overflow error can lead to erratic behavior because it causes an attempt to access data that does not exist. To handle this error, the index overflow circuit 515 reset the fetch index to an initial value, such as the value of 0, based on the determination that the fetch index exceeded the size of a video bitstream. The decode logic circuit 505 then continues to fetch data from this reset position to maintain the continuity of the decoding process.

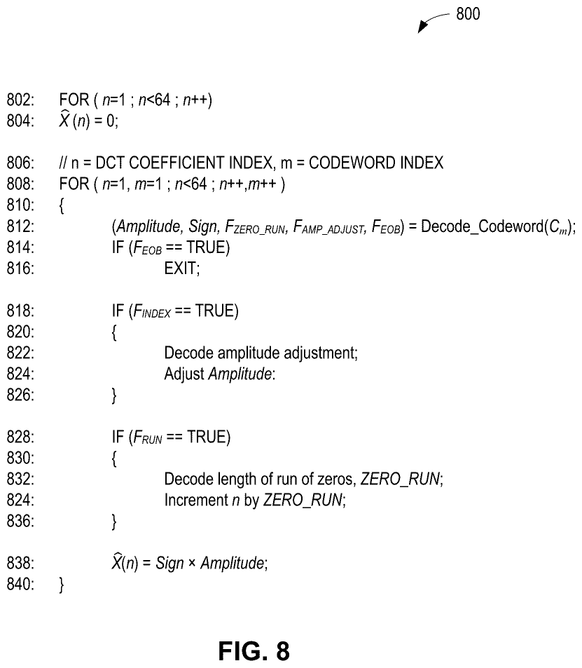

To provide context for the operation of the macroblock index error circuit 520, FIG. 8 illustrates an example coefficient block decoder algorithm 800 implemented by the decode logic circuit 505 of the entropy decoder circuit 500 of FIG. 5 to decode the coefficient block 700 of FIG. 7. The coefficient block decoder algorithm 800 corresponds to an VC-3-compliant algorithm to perform entropy decoding to obtain the quantized AC DCT coefficients (corresponding to non-frequencies) included in a given coefficient block 700. (The DC DCT coefficient corresponding a frequency of 0 is decoded differently.)

The example coefficient block decoder algorithm 800 begins with the decode logic circuit 505 of the entropy decoder circuit 500 initializing the AC DCT coefficients to 0 at pseudocode lines 802-804. Next, at pseudocode lines 806-810, the decode logic circuit 505 of the entropy decoder circuit 500 begins looping over the block index values of 1 to 63, which correspond to the indices of the different AC DCT coefficient included in the coefficient block 700. At pseudocode line 812, the decode logic circuit 505 of the entropy decoder circuit 500 decodes the fetched macroblock scan line data to obtain an amplitude (“Amplitude”) and sign (“Sign”) for the current AC DCT coefficient being decoded. At pseudocode line 812, the decode logic circuit 505 of the entropy decoder circuit 500 also obtains several flags associated with decoding the current AC DCT coefficient. The flags include an end-of-block flag (F_{EOB}), an amplitude index flag (F_{AMP_ADJUST}) and a zero-run flag (F_{ZERO_RUN}).

At pseudocode lines 814-816, the decode logic circuit 505 of the entropy decoder circuit 500 determines whether the decoding of the current AC DCT coefficient caused the end-of-block flag (F_{EOB}) to be set. If so, the decode logic circuit 505 of the entropy decoder circuit 500 determines the decoding of the coefficient block 700 is done and the algorithm 800 exits.

At pseudocode lines 818-826, the decode logic circuit 505 of the entropy decoder circuit 500 determines whether the decoding of the current AC DCT coefficient caused the amplitude index flag (F_{AMP_ADJUST}) to be set. If so, the decode logic circuit 505 of the entropy decoder circuit 500 decodes the fetched macroblock scan line data to determine an amplitude adjustment to be used to adjust the amplitude (Amplitude) of the current AC DCT coefficient being decoded. The decode logic circuit 505 of the entropy decoder circuit 500 then adjusts the amplitude (Amplitude) of the current AC DCT coefficient based on the amplitude adjustment as shown.

At pseudocode lines 828-836, the decode logic circuit 505 of the entropy decoder circuit 500 determines whether the decoding of the current AC DCT coefficient caused the zero-run flag (F_{ZERO_RUN}) to be set. The zero-run flag (F_{ZERO_RUN}) indicates there is a run of one or more zero-value AC DCT coefficients between the current AC DCT coefficient being decoded and the preceding non-zero AC DCT coefficient that was decoded previously. If the zero-run flag (F_{ZERO_RUN}) is set, the decode logic circuit 505 of the entropy decoder circuit 500 decodes the fetched macroblock scan line data to determine the number of zero-valued AC DCT coefficients that exist between the current AC DCT coefficient being decoded and the preceding non-zero AC DCT coefficient in the current DCT coefficient block 700 being decoded. The decode logic circuit 505 of the entropy decoder circuit 500 also increments the block index of the current AC DCT coefficient being decoded to account for the run of zero-valued DCT coefficients.

At pseudocode line 838, the decode logic circuit 505 of the entropy decoder circuit 500 decodes the current AC DCT coefficient by multiplying the decoded DCT coefficient amplitude (Amplitude) by the decoded DCT coefficient sign (Sign). At pseudocode line 840, the decode logic circuit 505 of the entropy decoder circuit 500 continues looping over the block index values of 1 to 63 until all the AC DCT coefficients in the current coefficient block 700 have been decoded.

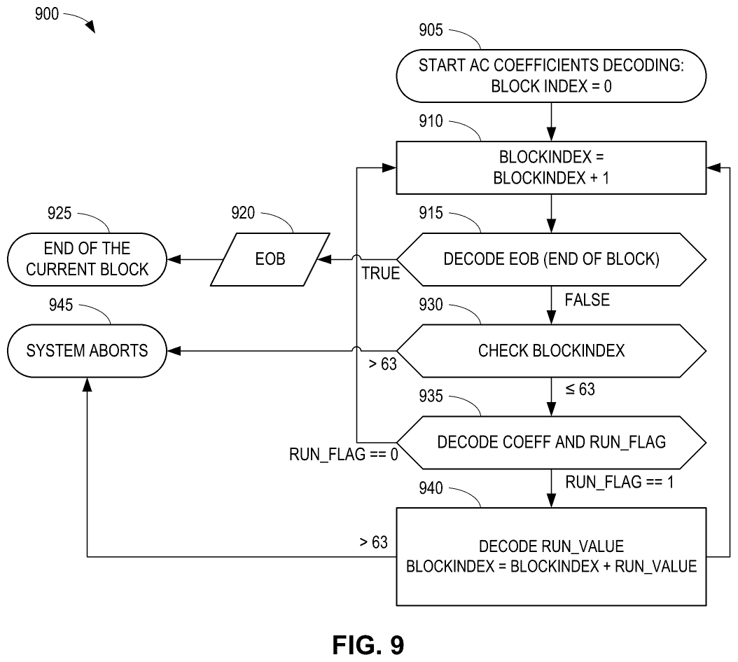

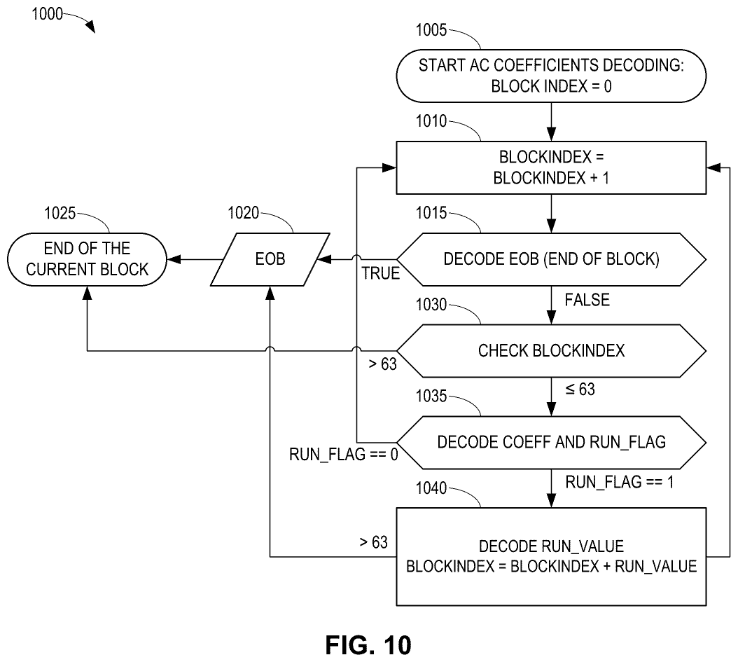

With the foregoing in mind, FIGS. 9-10 illustrate two example block index error handling algorithms 900 and 1000 that can be implemented by the macroblock index error circuit 520 to handle macroblock index errors that may occur when the entropy decoder circuit 500 executes the coefficient block decoder algorithm 800 of FIG. 8. Turning to FIG. 9, the illustrated example block index error handling algorithm 900 begins with the decode logic circuit 505 of the entropy decoder circuit 500 starting the decoding of the AC DCT coefficients for a current coefficient block 700 (corresponding to block 905) and incrementing the block index to correspond to the next AC DCT coefficient to be decoded (corresponding to block 910). Next, as described above in the context of FIG. 8, the decode logic circuit 505 of the entropy decoder circuit 500 determines whether the decoding of the next AC DCT coefficient has resulted in the end-of-block flag (F_{EOB}) being set (corresponding to block 915). As also described above, if the end-of-block flag (F_{EOB}) is set, the decode logic circuit 505 of the entropy decoder circuit 500 determines the decoding of the next AC DCT coefficient has reached the end of the current coefficient block 700 (corresponding to block 920), and the decode logic circuit 505 of the entropy decoder circuit 500 ends the decoding of the current coefficient block 700 (corresponding to block 925).

However, if the decode logic circuit 505 of the entropy decoder circuit 500 determines that the end-of-block flag (F_{EOB}) is not set, then the macroblock index error circuit 520 of the entropy decoder circuit 500 checks the current value of the block index being used by the decode logic circuit 505 to decode the next AC DCT coefficient (corresponding to block 930). If the current value of the block index exceeds a value corresponding to the number of coefficients in a coefficient block (e.g., if the block index exceeds 63 in the illustrated example, which corresponds to a total of 64 coefficients in a coefficient block), the macroblock index error circuit 520 of the entropy decoder circuit 500 identifies this anomaly as an error and consequently aborts the decoding process (corresponding to block 945).

However, if the macroblock index error circuit 520 of the entropy decoder circuit 500 determines the current value of the block index does not exceed the value corresponding to the number of coefficients in a coefficient block (e.g., if the block index does not exceed 63 in the illustrated example, which corresponds to a total of 64 coefficients in a coefficient block), then the decode logic circuit 505 of the entropy decoder circuit 500 decodes the next AC DCT coefficient and checks whether the zero-run flag (Fᵣᵤₙ) has been set (corresponding to block 935). If the zero-run flag (Fᵣᵤₙ) has not been set (e.g., corresponding to Fᵣᵤₙ=0 in the illustrated example), then the decode logic circuit 505 of the entropy decoder circuit 500 increments the block index to point to the next AC DCT coefficient to be decoded (corresponding to returning to block 910).

However, if the zero-run flag (Fᵣᵤₙ) has been set (e.g., corresponding to Fᵣᵤₙ=1 in the illustrated example), then the decode logic circuit 505 of the entropy decoder circuit 500 decodes the zero run value and increments the block index by the decoded zero run value (corresponding to block 940), as described above. The macroblock index error circuit 520 of the entropy decoder circuit 500 then checks the incremented value of the block index. If the macroblock index error circuit 520 of the entropy decoder circuit 500 determines the incremented value of the block index does not exceed the value corresponding to the number of coefficients in a coefficient block (e.g., if the incremented block index does not exceed 63 in the illustrated example, which corresponds to a total of 64 coefficients in a coefficient block), then the decode logic circuit 505 of the entropy decoder circuit 500 increments the block index to point to the next AC DCT coefficient to be decoded (corresponding to returning to block 910). However, if the current value of the block index exceeds the value corresponding to the number of coefficients in a coefficient block (e.g., if the block index exceeds 63 in the illustrated example, which corresponds to a total of 64 coefficients in a coefficient block), the macroblock index error circuit 520 of the entropy decoder circuit 500 identifies this anomaly as an error and consequently aborts the decoding process (corresponding to block 945).

Turning to FIG. 10, the illustrated example block index error handling algorithm 1000 improves over the block index error handling algorithm 900 by allowing decoding to continue rather than abort in the face of block index errors. The block index error handling algorithm 1000 of the illustrated example begins with the decode logic circuit 505 of the entropy decoder circuit 500 starting the decoding of the AC DCT coefficients for a current coefficient block 700 (corresponding to block 1005) and incrementing the block index to correspond to the next AC DCT coefficient to be decoded (corresponding to block 1010). Next, as described above in the context of FIG. 8, the decode logic circuit 505 of the entropy decoder circuit 500 determines whether the decoding of the next AC DCT coefficient has resulted in the end-of-block flag (F_{EOB}) being set (corresponding to block 1015). As also described above, if the end-of-block flag (F_{EOB}) is set, the decode logic circuit 505 of the entropy decoder circuit 500 determines the decoding of the next AC DCT coefficient has reached the end of the current coefficient block 700 (corresponding to block 1020), and the decode logic circuit 505 of the entropy decoder circuit 500 ends the decoding of the current coefficient block 700 (corresponding to block 1025).

However, if the decode logic circuit 505 of the entropy decoder circuit 500 determines that the end-of-block flag (F_{EOB}) is not set, then the macroblock index error circuit 520 of the entropy decoder circuit 500 checks the current value of the block index being used by the decode logic circuit 505 to decode the next AC DCT coefficient (corresponding to block 1030). If the current value of the block index exceeds a value corresponding to the number of coefficients in a coefficient block (e.g., if the block index exceeds 63 in the illustrated example, which corresponds to a total of 64 coefficients in a coefficient block), the macroblock index error circuit 520 of the entropy decoder circuit 500 identifies this anomaly as an error and ends the decoding of the current coefficient block 700 (corresponding to block 1025). Thus, the block index error handling algorithm 1000 gracefully ends the decoding of the current coefficient block 700 if this anomaly is detected (e.g., by dispatching an end-of-block (EOB) signal to the inverse quantizer and transformer circuit coupled to the entropy decoder circuit 500), rather than aborting the decoding process as is done by the block index error handling algorithm 900.

However, if the macroblock index error circuit 520 of the entropy decoder circuit 500 determines the current value of the block index does not exceed the value corresponding to the number of coefficients in a coefficient block (e.g., if the block index does not exceed 63 in the illustrated example, which corresponds to a total of 64 coefficients in a coefficient block), then the decode logic circuit 505 of the entropy decoder circuit 500 decodes the next AC DCT coefficient and checks whether the zero-run flag (Fᵣᵤₙ) has been set (corresponding to block 1035). If the zero-run flag (Fᵣᵤₙ) has not been set (e.g., corresponding to Fᵣᵤₙ=0 in the illustrated example), then the decode logic circuit 505 of the entropy decoder circuit 500 increments the block index to point to the next AC DCT coefficient to be decoded (corresponding to returning to block 1010).

However, if the zero-run flag (Fᵣᵤₙ) has been set (e.g., corresponding to Fᵣᵤₙ=1 in the illustrated example), then the decode logic circuit 505 of the entropy decoder circuit 500 decodes the zero run value and increments the block index by the decoded zero run value (corresponding to block 1040), as described above. The macroblock index error circuit 520 of the entropy decoder circuit 500 then checks the incremented value of the block index. If the macroblock index error circuit 520 of the entropy decoder circuit 500 determines the incremented value of the block index does not exceed the value corresponding to the number of coefficients in a coefficient block (e.g., if the incremented block index does not exceed 63 in the illustrated example, which corresponds to a total of 64 coefficients in a coefficient block), then the decode logic circuit 505 of the entropy decoder circuit 500 increments the block index to point to the next AC DCT coefficient to be decoded (corresponding to returning to block 1010). However, if the current value of the block index exceeds the value corresponding to the number of coefficients in a coefficient block (e.g., if the block index exceeds 63 in the illustrated example, which corresponds to a total of 64 coefficients in a coefficient block), the macroblock index error circuit 520 of the entropy decoder circuit 500 identifies this anomaly as an error and ends the decoding of the current coefficient block 700 (corresponding to block 1025). Thus, the block index error handling algorithm 1000 gracefully ends the decoding of the current coefficient block 700 if this anomaly is detected (e.g., by dispatching an EOB signal to the inverse quantizer and transformer circuit coupled to the entropy decoder circuit 500), rather than aborting the decoding process as is done by the block index error handling algorithm 900.

Thus, the block index error handling algorithm 1000 enables the entropy decoder circuit 500 to decode data associated with the first macroblock scan line into blocks of coefficients, and end decoding of one of the blocks of coefficients based on a determination that a block index of a next coefficient to be decoded exceeds a number of coefficients in the one of the blocks. For example, the entropy decoder circuit 500 may increment the block index based on a run of zero-value coefficients indicated in the data associated with the first macroblock scan line, and determine whether incrementing the block index will cause the block index to exceed the number of coefficients in the one of the blocks.

Returning to FIG. 5, the bitstream underflow circuit 525 handles bitstream underflow errors that may occur when the entropy decoder circuit 500 reads data for an encoded macroblock scan line from the input memory 405. For example, the decode logic circuit 505 of the entropy decoder circuit 500 may perform data fetches associated with a given macroblock scan line based on a fetch index. Should the decode logic circuit 505 exhaust the available bitstream data before completing the decoding of the current macroblock scan line, the bitstream underflow circuit 525 preemptively generates an additional recovery bitstream to be used by the decode logic circuit 505 to continued decoding of the current macroblock scan line. For example, the bitstream underflow circuit 525 may generate a recovery bitstream containing random values, a default constant value, data retained for a prior macroblock scan line, etc. This action ensures the decoding process continues seamlessly based on the recovery data after detection of the bitstream underflow error, allowing the decode logic circuit 505 to fully decode the current macroblock scan line without interruption.

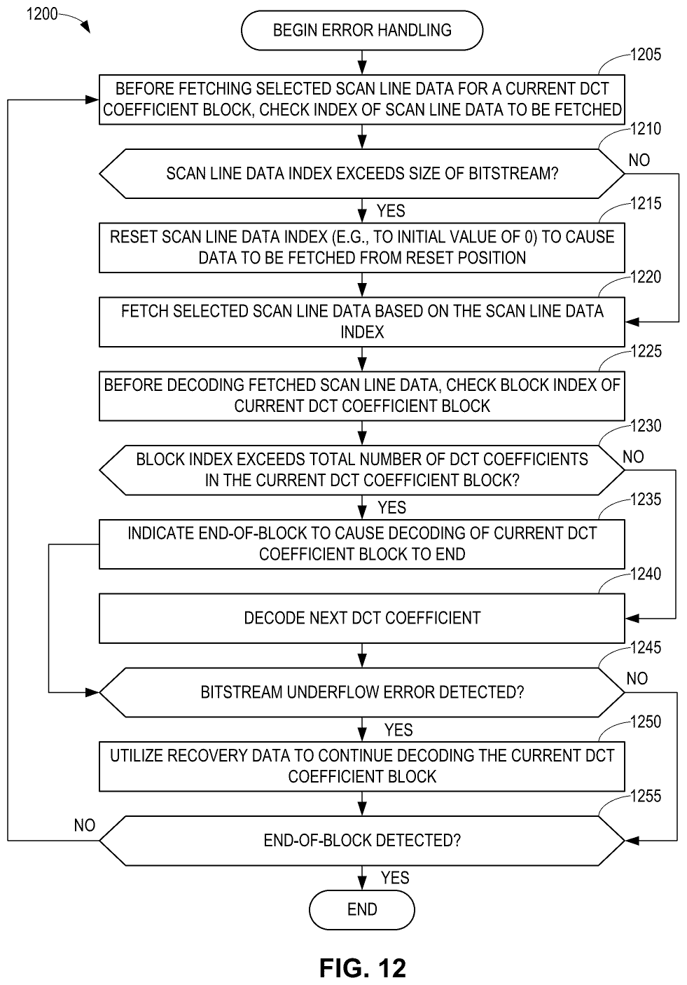

In some examples, the entropy decoder circuit 500 includes means for handling scanline index overflow errors. For example, the means for handling scanline index overflow errors may be implemented by the scanline index overflow circuit 515. In some examples, the scanline index overflow circuit 515 may be instantiated by programmable circuitry such as the example programmable circuitry 1312 of FIG. 13. For instance, the scanline index overflow circuit 515 may be instantiated by the example microprocessor 1400 of FIG. 14 executing machine executable instructions such as those implemented by at least blocks 1205-1220 of FIG. 12. In some examples, the scanline index overflow circuit 515 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the scanline index overflow circuit 515 may be instantiated by any other combination of hardware, software, and/or firmware. For example, the scanline index overflow circuit 515 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the entropy decoder circuit 500 includes means for handling macroblock index errors. For example, the means for handling macroblock index errors may be implemented by the macroblock index error circuit 520. In some examples, the macroblock index error circuit 520 may be instantiated by programmable circuitry such as the example programmable circuitry 1312 of FIG. 13. For instance, the macroblock index error circuit 520 may be instantiated by the example microprocessor 1400 of FIG. 14 executing machine executable instructions such as those implemented by at least blocks 1225-1240 of FIG. 12. In some examples, the macroblock index error circuit 520 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the macroblock index error circuit 520 may be instantiated by any other combination of hardware, software, and/or firmware. For example, the macroblock index error circuit 520 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the entropy decoder circuit 500 includes means for handling bitstream underflow errors. For example, the means for handling bitstream underflow errors may be implemented by the bitstream underflow circuit 525. In some examples, the bitstream underflow circuit 525 may be instantiated by programmable circuitry such as the example programmable circuitry 1312 of FIG. 13. For instance, the bitstream underflow circuit 525 may be instantiated by the example microprocessor 1400 of FIG. 14 executing machine executable instructions such as those implemented by at least blocks 1245-1250 of FIG. 12. In some examples, the bitstream underflow circuit 525 may be instantiated by hardware logic circuitry, which may be implemented by an ASIC, XPU, or the FPGA circuitry 1500 of FIG. 15 configured and/or structured to perform operations corresponding to the machine-readable instructions. Additionally or alternatively, the bitstream underflow circuit 525 may be instantiated by any other combination of hardware, software, and/or firmware. For example, the bitstream underflow circuit 525 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

While an example manner of implementing the video decoder circuit 300 is illustrated in FIGS. 3-10, one or more of the elements, processes, and/or devices illustrated in FIGS. 3-10 may be combined, divided, re-arranged, omitted, eliminated, and/or implemented in any other way. Further, the example macroblock scan line decoder circuits 305A-C, the example pixel decode circuits 310A-C, the example alpha decode circuits 315A-C, the example header parser circuit 335, the example workload manager circuit 340, the example entropy decoder circuits 415A-C and/or 500, the example inverse quantizer and transformer circuits 420A-C, the latency reduction buffers 430A-C, the example format converter circuits 425A-C, the example decode logic circuit 505, the example error handling circuit 510, the example scanline index overflow circuit 515, the example macroblock index error circuit 520, the example bitstream underflow circuit 525, and/or, more generally, the example video decoder circuit 300 of FIGS. 3-10, may be implemented by hardware alone or by hardware in combination with software and/or firmware. Thus, for example, any of the example macroblock scan line decoder circuits 305A-C, the example pixel decode circuits 310A-C, the example alpha decode circuits 315A-C, the example header parser circuit 335, the example workload manager circuit 340, the example entropy decoder circuits 415A-C and/or 500, the example inverse quantizer and transformer circuits 420A-C, the latency reduction buffers 430A-C, the example format converter circuits 425A-C, the example decode logic circuit 505, the example error handling circuit 510, the example scanline index overflow circuit 515, the example macroblock index error circuit 520, the example bitstream underflow circuit 525, and/or, more generally, the example video decoder circuit 300, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the example video decoder circuit 300 may include one or more elements, processes, and/or devices in addition to, or instead of, those illustrated in FIGS. 3-10, and/or may include more than one of any or all of the illustrated elements, processes and devices.

Flowchart(s) representative of example machine-readable instructions, which may be executed by programmable circuitry to implement and/or instantiate the video decoder circuit 300 of FIGS. 3-10 and/or representative of example operations which may be performed by programmable circuitry to implement and/or instantiate the video decoder circuit 300 of FIGS. 3-10, are shown in FIGS. 11-12. The machine-readable instructions may be one or more executable programs or portion(s) of one or more executable programs for execution by programmable circuitry such as the programmable circuitry 1312 shown in the example processor platform 1300 discussed below in connection with FIG. 13 and/or may be one or more function(s) or portion(s) of functions to be performed by the example programmable circuitry (e.g., an FPGA) discussed below in connection with FIGS. 14 and/or 15. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 11-12, many other methods of implementing the example video decoder circuit 300 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 11-12 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 11 is a flowchart representative of example machine-readable instructions and/or example operations 1100 that may be executed, instantiated, and/or performed by programmable circuitry to implement VC-3 video decoding in the video decoder circuit 300 of FIGS. 3-4. The example machine-readable instructions and/or the example operations 1100 of FIG. 11 begin at block 1102 at which the workload manager circuit 340 of the video decoder circuit 300 accesses a job request to decode a VC-3 encoded video frame. At block 1104, the header parser circuit 335 of the video decoder circuit 300 parses the VC-3 header of the encoded video frame, as described above. At block 1106, the workload manager circuit 340 configures the macroblock scan line decoder circuits 305A-C of the video decoder circuit 300 based on the parsed VC-3 header, as described above. At block 1108, the macroblock scan line decoder circuits 305A-C are also configured based on a load balancing algorithm, if applicable, as described above.

At blocks 1110, 1130 and 1150, the macroblock scan line decoder circuits 305A-C begin decoding respective different macroblock scan lines of the encoded video frame in parallel (e.g., concurrently). For example, at block 1110, the entropy decoder circuit 415A of the macroblock scan line decoder circuit 305A selects a next scan line to fetch according to the load balancing algorithm, as described above. At block 1112, the entropy decoder circuit 415A fetches a portion of the selected macroblock scan line from the input memory 405 and stores the fetched data in the latency reduction buffer 430A. At block 1114, the entropy decoder circuit 415A, the inverse quantizer and transformer circuit 420A and the format converter circuit 425A operate, as described above, to decode the fetched scan line data from the latency reduction buffer 430A. At block 1116, the entropy decoder circuit 415A determines whether the end of the selected macroblock scan line has been reached. If not (corresponding to the “NO” output of block 1116), processing returns to block 1112 and blocks subsequent thereto at which the entropy decoder circuit 415A fetches additional portion(s) of the selected macroblock scan line, and stores the fetched data in the latency reduction buffer 430A for subsequent decoding. However, if the end of the selected macroblock scan line has been reached (corresponding to the “YES” output of block 1116), then at block 1118 the entropy decoder circuit 415A determines whether there are additional macroblock scan lines to be decoded. If there are additional macroblock scan lines to decode (corresponding to the “YES” output of block 1118), processing returns to block 1110 and blocks subsequent thereto at which the entropy decoder circuit 415A selects a next macroblock scan line to be fetched and decoded. However, if there are no additional macroblock scan lines to decode (corresponding to the “NO” output of block 1118), then the entropy decoder circuit 415A outputs a signal to the workload manager circuit 340 to indicate decoding of the current frame by the macroblock scan line decoder circuit 305A is complete.

Likewise, in parallel (e.g., concurrently), at block 1130, the entropy decoder circuit 415B of the macroblock scan line decoder circuit 305B selects a next scan line to fetch according to the load balancing algorithm, as described above. At block 1132, the entropy decoder circuit 415B fetches a portion of the selected macroblock scan line from the input memory 405 and stores the fetched data in the latency reduction buffer 430B. At block 1134, the entropy decoder circuit 415B, the inverse quantizer and transformer circuit 420B and the format converter circuit 425B operate, as described above, to decode the fetched scan line data from the latency reduction buffer 430B. At block 1136, the entropy decoder circuit 415B determines whether the end of the selected macroblock scan line has been reached. If not (corresponding to the “NO” output of block 1136), processing returns to block 1132 and blocks subsequent thereto at which the entropy decoder circuit 415B fetches additional portion(s) of the selected macroblock scan line, and stores the fetched data in the latency reduction buffer 430B for subsequent decoding. However, if the end of the selected macroblock scan line has been reached (corresponding to the “YES” output of block 1136), then at block 1138 the entropy decoder circuit 415B determines whether there are additional macroblock scan lines to be decoded. If there are additional macroblock scan lines to decode (corresponding to the “YES” output of block 1138), processing returns to block 1130 and blocks subsequent thereto at which the entropy decoder circuit 415B selects a next macroblock scan line to be fetched and decoded. However, if there are no additional macroblock scan lines to decode (corresponding to the “NO” output of block 1138), then the entropy decoder circuit 415B outputs a signal to the workload manager circuit 340 to indicate decoding of the current frame by the macroblock scan line decoder circuit 305B is complete.

Likewise, in parallel (e.g., concurrently), at block 1150, the entropy decoder circuit 415C of the macroblock scan line decoder circuit 305C selects a next scan line to fetch according to the load balancing algorithm, as described above. At block 1152, the entropy decoder circuit 415C fetches a portion of the selected macroblock scan line from the input memory 405 and stores the fetched data in the latency reduction buffer 430C. At block 1154, the entropy decoder circuit 415C, the inverse quantizer and transformer circuit 420C and the format converter circuit 425C operate, as described above, to decode the fetched scan line data from the latency reduction buffer 430C. At block 1156, the entropy decoder circuit 415C determines whether the end of the selected macroblock scan line has been reached. If not (corresponding to the “NO” output of block 1156), processing returns to block 1152 and blocks subsequent thereto at which the entropy decoder circuit 415C fetches additional portion(s) of the selected macroblock scan line, and stores the fetched data in the latency reduction buffer 430C for subsequent decoding. However, if the end of the selected macroblock scan line has been reached (corresponding to the “YES” output of block 1156), then at block 1158 the entropy decoder circuit 415C determines whether there are additional macroblock scan lines to be decoded. If there are additional macroblock scan lines to decode (corresponding to the “YES” output of block 1158), processing returns to block 1150 and blocks subsequent thereto at which the entropy decoder circuit 415C selects a next macroblock scan line to be fetched and decoded. However, if there are no additional macroblock scan lines to decode (corresponding to the “NO” output of block 1158), then the entropy decoder circuit 415C outputs a signal to the workload manager circuit 340 to indicate decoding of the current frame by the macroblock scan line decoder circuit 305C is complete.

At block 1162, the workload manager circuit 340 evaluates the status the decoding complete signals provided by the macroblock scan line decoder circuits 305A-C. After the workload manager circuit 340 detects that all of the macroblock scan line decoder circuits 305A-C have asserted their respective decoding complete signals, the workload manager circuit 340 returns a message in response to the job request to indicate the decoded video frame is available in the output memory 410. The example machine-readable instructions and/or the example operations 1100 of FIG. 11 then end for the current video frame.

FIG. 12 is a flowchart representative of example machine-readable instructions and/or example operations 1200 that may be executed, instantiated, and/or performed by programmable circuitry to implement error handling in the video decoder circuit 300 of FIGS. 3-5. The example machine-readable instructions and/or the example operations 1200 of FIG. 12 begin at block 1205 at which the scanline index overflow circuit 515 of the entropy decoder circuit 500 checks, before selected scan line data for a current DCT coefficient block is fetched, the value of the fetch index for the scan line data to be fetched, as described above. For example, at block 1210, the scanline index overflow circuit 515 determines whether the fetch index exceeds a size of the bitstream, as described above. If the fetch index exceeds the size of the bitstream (corresponding to the “YES” output of block 1210), then at block 1215, the scanline index overflow circuit 515 resets fetch index (e.g., to initial value of 0) to cause data to be fetched from reset position at block 1220, as described above. Otherwise (corresponding to the “NO” output of block 1210), the fetch index remains unchanged, and at block 1220 the entropy decoder circuit 500 fetches scan line data based on the fetch index, as described above.

At block 1225, the macroblock index error circuit 520 of the entropy decoder circuit 500 checks, before decoding fetched scan line data, the block index of current DCT coefficient block being decoded, as described above. For example, at block 1230, the macroblock index error circuit 520 determines whether the block index exceeds total number of DCT coefficients in the current DCT coefficient block. If so (corresponding to the “YES” output of block 1230), the macroblock index error circuit 520 indicates an end-of-block condition to cause decoding of current DCT coefficient block to end, as described above. Otherwise (corresponding to the “YES” output of block 1230), the macroblock index error circuit 520 permits the entropy decoder circuit 500 to decode the next DCT coefficient of the block.

At block 1245, the bitstream underflow circuit 525 of the entropy decoder circuit 500 determines whether a bitstream underflow error has been detected, as described above. If a bitstream underflow error is detected (corresponding to the “YES” output of block 1245), at block 1250 the bitstream underflow circuit 525 utilizes (e.g., generates) recovery data, as described above, to permit the entropy decoder circuit 500 to continue decoding the current DCT coefficient block. Otherwise (corresponding to the “NO” output of block 1245), the entropy decoder circuit 500 continues decoding based on the fetched scan line data. At block 1255, the entropy decoder circuit 500 determines whether decoding of the current DCT coefficient has resulted in an end-of-block condition, as described above. If an end-of-block condition has occurred (corresponding to the “YES” output of block 1255), then the example machine-readable instructions and/or the example operations 1200 of FIG. 12 end. Otherwise (corresponding to the “NO” output of block 1255), processing returns to block 1205 and blocks subsequent thereto to permit the entropy decoder circuit 500 to continued decoding DCT coefficients in the current coefficient block.

FIG. 13 is a block diagram of an example programmable circuitry platform 1300 structured to execute and/or instantiate the example machine-readable instructions and/or the example operations of FIGS. 11-12 to implement the video decoder circuit 300 of FIGS. 3-10. The programmable circuitry platform 1300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1300 of the illustrated example includes programmable circuitry 1312. The programmable circuitry 1312 of the illustrated example is hardware. For example, the programmable circuitry 1312 can be implemented by one or more integrated circuits, logic circuits, FPGAs, microprocessors, CPUs, GPUs, VPUs, DSPs, and/or microcontrollers from any desired family or manufacturer. The programmable circuitry 1312 may be implemented by one or more semiconductor based (e.g., silicon based) devices. In some examples, the programmable circuitry 1312 implements the video decoder circuit 300. However, in some examples, the programmable circuitry 1312 implements one or more portions of the video decoder circuit 300, such as the header parser circuit 335 and/or the workload manager circuit 340, whereas the other portion(s) of the video decoder circuit 300, such as the macroblock scan line decoder circuits 305A-C, are implemented as one or more example hardware accelerator circuits 305 in communication with the programmable circuitry 1312.

The programmable circuitry 1312 of the illustrated example includes a local memory 1313 (e.g., a cache, registers, etc.). The programmable circuitry 1312 of the illustrated example is in communication with main memory 1314, 1316, which includes a volatile memory 1314 and a non-volatile memory 1316, by a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1316 may be implemented by flash memory and/or any other desired type of memory device. Access to the main memory 1314, 1316 of the illustrated example is controlled by a memory controller 1317. In some examples, the memory controller 1317 may be implemented by one or more integrated circuits, logic circuits, microcontrollers from any desired family or manufacturer, or any other type of circuitry to manage the flow of data going to and from the main memory 1314, 1316. In some examples, the local memory 1313 and/or the volatile memory 1314 implement the input memory 405 and/or the output memory 410.

The programmable circuitry platform 1300 of the illustrated example also includes interface circuitry 1320. The interface circuitry 1320 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1322 are connected to the interface circuitry 1320. The input device(s) 1322 permit(s) a user (e.g., a human user, a machine user, etc.) to enter data and/or commands into the programmable circuitry 1312. The input device(s) 1322 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1324 are also connected to the interface circuitry 1320 of the illustrated example. The output device(s) 1324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1320 of the illustrated example, thus, typically includes a graphics driver card, a graphics driver chip, and/or graphics processor circuitry such as a GPU.

The interface circuitry 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1326. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1300 of the illustrated example also includes one or more mass storage discs or devices 1328 to store firmware, software, and/or data. Examples of such mass storage discs or devices 1328 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs. In some examples, one or more of the one or more mass storage discs or devices 1328 implement the input memory 405 and/or the output memory 410.

The machine-readable instructions 1332, which may be implemented by the machine-readable instructions of FIGS. 11-12, may be stored in the mass storage device 1328, in the volatile memory 1314, in the non-volatile memory 1316, and/or on at least one non-transitory computer-readable storage medium such as a CD or DVD which may be removable.

FIG. 14 is a block diagram of an example implementation of the programmable circuitry 1312 of FIG. 13. In this example, the programmable circuitry 1312 of FIG. 13 is implemented by a microprocessor 1400. For example, the microprocessor 1400 may be a general-purpose microprocessor (e.g., general-purpose microprocessor circuitry). The microprocessor 1400 executes some or all of the machine-readable instructions of the flowcharts of FIGS. 11-12 to effectively instantiate the circuitry of FIGS. 3-10 as logic circuits to perform operations corresponding to those machine-readable instructions. In some such examples, the circuitry of FIGS. 3-10 is instantiated by the hardware circuits of the microprocessor 1400 in combination with the machine-readable instructions. For example, the microprocessor 1400 may be implemented by multi-core hardware circuitry such as a CPU, a DSP, a GPU, an XPU, etc. Although it may include any number of example cores 1402 (e.g., 1 core), the microprocessor 1400 of this example is a multi-core semiconductor device including N cores. The cores 1402 of the microprocessor 1400 may operate independently or may cooperate to execute machine-readable instructions. For example, machine code corresponding to a firmware program, an embedded software program, or a software program may be executed by one of the cores 1402 or may be executed by multiple ones of the cores 1402 at the same or different times. In some examples, the machine code corresponding to the firmware program, the embedded software program, or the software program is split into threads and executed in parallel by two or more of the cores 1402. The software program may correspond to a portion or all of the machine-readable instructions and/or operations represented by the flowcharts of FIGS. 11-12.

The cores 1402 may communicate by a first example bus 1404. In some examples, the first bus 1404 may be implemented by a communication bus to effectuate communication associated with one(s) of the cores 1402. For example, the first bus 1404 may be implemented by at least one of an Inter-Integrated Circuit (I2C) bus, a Serial Peripheral Interface (SPI) bus, a PCI bus, or a PCIe bus. Additionally or alternatively, the first bus 1404 may be implemented by any other type of computing or electrical bus. The cores 1402 may obtain data, instructions, and/or signals from one or more external devices by example interface circuitry 1406. The cores 1402 may output data, instructions, and/or signals to the one or more external devices by the interface circuitry 1406. Although the cores 1402 of this example include example local memory 1420 (e.g., Level 1 (L1) cache that may be split into an L1 data cache and an L1 instruction cache), the microprocessor 1400 also includes example shared memory 1410 that may be shared by the cores (e.g., Level 2 (L2cache)) for high-speed access to data and/or instructions. Data and/or instructions may be transferred (e.g., shared) by writing to and/or reading from the shared memory 1410. The local memory 1420 of each of the cores 1402 and the shared memory 1410 may be part of a hierarchy of storage devices including multiple levels of cache memory and the main memory (e.g., the main memory 1314, 1316 of FIG. 13). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1402 may be referred to as a CPU, DSP, GPU, etc., or any other type of hardware circuitry. Each core 1402 includes control unit circuitry 1414, arithmetic and logic (AL) circuitry (sometimes referred to as an ALU) 1416, a plurality of registers 1418, the local memory 1420, and a second example bus 1422. Other structures may be present. For example, each core 1402 may include vector unit circuitry, single instruction multiple data (SIMD) unit circuitry, load/store unit (LSU) circuitry, branch/jump unit circuitry, floating-point unit (FPU) circuitry, etc. The control unit circuitry 1414 includes semiconductor-based circuits structured to control (e.g., coordinate) data movement within the corresponding core 1402. The AL circuitry 1416 includes semiconductor-based circuits structured to perform one or more mathematic and/or logic operations on the data within the corresponding core 1402. The AL circuitry 1416 of some examples performs integer based operations. In other examples, the AL circuitry 1416 also performs floating-point operations. In yet other examples, the AL circuitry 1416 may include first AL circuitry that performs integer-based operations and second AL circuitry that performs floating-point operations. In some examples, the AL circuitry 1416 may be referred to as an Arithmetic Logic Unit (ALU).

The registers 1418 are semiconductor-based structures to store data and/or instructions such as results of one or more of the operations performed by the AL circuitry 1416 of the corresponding core 1402. For example, the registers 1418 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1418 may be arranged in a bank as shown in FIG. 14. Alternatively, the registers 1418 may be organized in any other arrangement, format, or structure, such as by being distributed throughout the core 1402 to shorten access time. The second bus 1422 may be implemented by at least one of an I2C bus, a SPI bus, a PCI bus, or a PCIe bus.

Each core 1402 and/or, more generally, the microprocessor 1400 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1400 is a semiconductor device fabricated to include many transistors interconnected to implement the structures described above in one or more integrated circuits (ICs) contained in one or more packages.

The microprocessor 1400 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1400, in the same chip package as the microprocessor 1400 and/or in one or more separate packages from the microprocessor 1400.

FIG. 15 is a block diagram of another example implementation of the programmable circuitry 1312 of FIG. 13. In this example, the programmable circuitry 1312 is implemented by FPGA circuitry 1500. For example, the FPGA circuitry 1500 may be implemented by an FPGA. The FPGA circuitry 1500 can be used, for example, to perform operations that could otherwise be performed by the example microprocessor 1400 of FIG. 14 executing corresponding machine-readable instructions. However, once configured, the FPGA circuitry 1500 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1400 of FIG. 14 described above (which is a general purpose device that may be programmed to execute some or all of the machine-readable instructions represented by the flowchart(s) of FIGS. 11-12 but whose interconnections and logic circuitry are fixed once fabricated), the FPGA circuitry 1500 of the example of FIG. 15 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 11-12. In particular, the FPGA circuitry 1500 may be thought of as an array of logic gates, interconnections, and switches. The switches can be programmed to change how the logic gates are interconnected by the interconnections, effectively forming one or more dedicated logic circuits (unless and until the FPGA circuitry 1500 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 11-12. As such, the FPGA circuitry 1500 may be configured and/or structured to effectively instantiate some or all of the operations/functions corresponding to the machine-readable instructions of the flowchart(s) of FIGS. 11-12 as dedicated logic circuits to perform the operations/functions corresponding to those software instructions in a dedicated manner analogous to an ASIC. Therefore, the FPGA circuitry 1500 may perform the operations/functions corresponding to the some or all of the machine-readable instructions of FIGS. 11-12 faster than the general-purpose microprocessor can execute the same.

In the example of FIG. 15, the FPGA circuitry 1500 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1500 of FIG. 15 may access and/or load the binary file to cause the FPGA circuitry 1500 of FIG. 15 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1500 of FIG. 15 to cause configuration and/or structuring of the FPGA circuitry 1500 of FIG. 15, or portion(s) thereof.

The FPGA circuitry 1500 of FIG. 15, includes example input/output (I/O) circuitry 1502 to obtain and/or output data to/from example configuration circuitry 1504 and/or external hardware 1506. For example, the configuration circuitry 1504 may be implemented by interface circuitry that may obtain a binary file, which may be implemented by a bit stream, data, and/or machine-readable instructions, to configure the FPGA circuitry 1500, or portion(s) thereof. In some such examples, the configuration circuitry 1504 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1506 may be implemented by external hardware circuitry. For example, the external hardware 1506 may be implemented by the microprocessor 1400 of FIG. 14.

The FPGA circuitry 1500 also includes an array of example logic gate circuitry 1508, a plurality of example configurable interconnections 1510, and example storage circuitry 1512. The logic gate circuitry 1508 and the configurable interconnections 1510 are configurable to instantiate one or more operations/functions that may correspond to at least some of the machine-readable instructions of FIGS. 11-12 and/or other desired operations. The logic gate circuitry 1508 shown in FIG. 15 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1508 to enable configuration of the electrical structures and/or the logic gates to form circuits to perform desired operations/functions. The logic gate circuitry 1508 may include other electrical structures such as look-up tables (LUTs), registers (e.g., flip-flops or latches), multiplexers, etc.

The configurable interconnections 1510 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1508 to program desired logic circuits.

The storage circuitry 1512 of the illustrated example is structured to store result(s) of the one or more of the operations performed by corresponding logic gates. The storage circuitry 1512 may be implemented by registers or the like. In the illustrated example, the storage circuitry 1512 is distributed amongst the logic gate circuitry 1508 to facilitate access and increase execution speed.

The example FPGA circuitry 1500 of FIG. 15 also includes example dedicated operations circuitry 1514. In this example, the dedicated operations circuitry 1514 includes special purpose circuitry 1516 that may be invoked to implement commonly used functions to avoid the need to program those functions in the field. Examples of such special purpose circuitry 1516 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1500 may also include example general purpose programmable circuitry 1518 such as an example CPU 1520 and/or an example DSP 1522. Other general purpose programmable circuitry 1518 may additionally or alternatively be present such as a GPU, an XPU, etc., that can be programmed to perform other operations.

Although FIGS. 14 and 15 illustrate two example implementations of the programmable circuitry 1312 of FIG. 13, many other approaches are contemplated. For example, FPGA circuitry may include an on-board CPU, such as one or more of the example CPU 1520 of FIG. 14. Therefore, the programmable circuitry 1312 of FIG. 13 may additionally be implemented by combining at least the example microprocessor 1400 of FIG. 14 and the example FPGA circuitry 1500 of FIG. 15. In some such hybrid examples, one or more cores 1402 of FIG. 14 may execute a first portion of the machine-readable instructions represented by the flowchart(s) of FIGS. 11-12 to perform first operation(s)/function(s), the FPGA circuitry 1500 of FIG. 15 may be configured and/or structured to perform second operation(s)/function(s) corresponding to a second portion of the machine-readable instructions represented by the flowcharts of FIG. 11-12, and/or an ASIC may be configured and/or structured to perform third operation(s)/function(s) corresponding to a third portion of the machine-readable instructions represented by the flowcharts of FIGS. 11-12.

It should be understood that some or all of the circuitry of FIGS. 3-10 may, thus, be instantiated at the same or different times. For example, same and/or different portion(s) of the microprocessor 1400 of FIG. 14 may be programmed to execute portion(s) of machine-readable instructions at the same and/or different times. In some examples, same and/or different portion(s) of the FPGA circuitry 1500 of FIG. 15 may be configured and/or structured to perform operations/functions corresponding to portion(s) of machine-readable instructions at the same and/or different times.

In some examples, some or all of the circuitry of FIGS. 3-10 may be instantiated, for example, in one or more threads executing concurrently and/or in series. For example, the microprocessor 1400 of FIG. 14 may execute machine-readable instructions in one or more threads executing concurrently and/or in series. In some examples, the FPGA circuitry 1500 of FIG. 15 may be configured and/or structured to carry out operations/functions concurrently and/or in series. Moreover, in some examples, some or all of the circuitry of FIGS. 3-10 may be implemented within one or more virtual machines and/or containers executing on the microprocessor 1400 of FIG. 14.

In some examples, the programmable circuitry 1312 of FIG. 13 may be in one or more packages. For example, the microprocessor 1400 of FIG. 14 and/or the FPGA circuitry 1500 of FIG. 15 may be in one or more packages. In some examples, an XPU may be implemented by the programmable circuitry 1312 of FIG. 13, which may be in one or more packages. For example, the XPU may include a CPU (e.g., the microprocessor 1400 of FIG. 14, the CPU 1520 of FIG. 15, etc.) in one package, a DSP (e.g., the DSP 1522 of FIG. 15) in another package, a GPU in yet another package, and an FPGA (e.g., the FPGA circuitry 1500 of FIG. 15) in still yet another package.

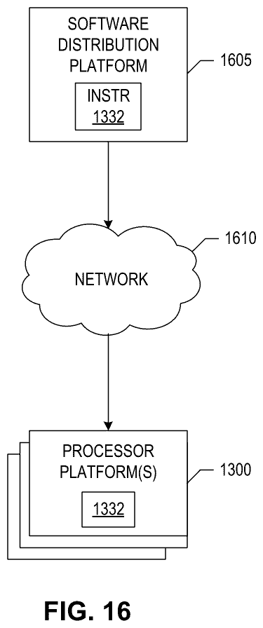

A block diagram illustrating an example software distribution platform 1605 to distribute software such as the example machine-readable instructions 1332 of FIG. 13 to other hardware devices (e.g., hardware devices owned and/or operated by third parties from the owner and/or operator of the software distribution platform) is illustrated in FIG. 16. The example software distribution platform 1605 may be implemented by any computer server, data facility, cloud service, etc., capable of storing and transmitting software to other computing devices. The third parties may be customers of the entity owning and/or operating the software distribution platform 1605. For example, the entity that owns and/or operates the software distribution platform 1605 may be a developer, a seller, and/or a licensor of software such as the example machine-readable instructions 1332 of FIG. 13. The third parties may be consumers, users, retailers, OEMs, etc., who purchase and/or license the software for use and/or re-sale and/or sub-licensing. In the illustrated example, the software distribution platform 1605 includes one or more servers and one or more storage devices. The storage devices store the machine-readable instructions 1332, which may correspond to the example machine-readable instructions of FIGS. 11-12, as described above. The one or more servers of the example software distribution platform 1605 are in communication with an example network 1610, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 1332 from the software distribution platform 1605. For example, the software, which may correspond to the example machine-readable instructions of FIG. 11-12, may be downloaded to the example programmable circuitry platform 1300, which is to execute the machine-readable instructions 1332 to implement the video decoder circuit 300. In some examples, one or more servers of the software distribution platform 1605 periodically offer, transmit, and/or force updates to the software (e.g., the example machine-readable instructions 1332 of FIG. 13) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that implement video decoders that perform parallel macroblock scan line decoding and error handling. Disclosed systems, apparatus, articles of manufacture, and methods improve the efficiency of using a computing device by providing a video decoder that includes multiple macroblock scan line decoders that operate in parallel to fetch and decode multiple different scan lines of an encoded video frame in parallel (e.g., concurrently), thereby improving the rate at which video frames can be decoded by the computing system. Furthermore, at least some video decoders disclosed herein implement error handling to permit video decoding to continue in the face of one or more different types of decoding errors, thereby preventing the computing device from freezing, crashing and/or dropping frames due to decoding errors. Disclosed systems, apparatus, articles of manufacture, and methods are accordingly directed to one or more improvement(s) in the operation of a machine such as a computer or other electronic and/or mechanical device.

Further examples and combinations thereof include the following. Example 1 includes an apparatus comprising a first decoder circuit to decode a first macroblock scan line of an encoded video frame, the first decoder circuit to fetch the first macroblock scan line from memory based on a load balancing algorithm, and a second decoder circuit to decode a second macroblock scan line of the encoded video frame, the second macroblock scan line different from the first macroblock scan line, the second decoder circuit to fetch the second macroblock scan line from the memory based on the load balancing algorithm, the first decoder circuit to decode the first macroblock scan line and the second decoder circuit to decode the second macroblock scan line in parallel.

Example 2 includes any preceding clause(s) of example 1, wherein the encoded video frame includes a plurality macroblock scan lines, the load balancing algorithm is a round-robin algorithm, and the first decoder circuit includes a first input and a second input, the first input of the first decoder circuit to specify a number of macroblock scan lines to be decoded in parallel, the second input of the first decoder circuit to specify a first modulo value, the first decoder circuit to successively fetch first ones of the macroblock scan lines to decode based on the first modulo value, the first ones of the macroblock scan lines including the first macroblock scan line, and the second decoder circuit includes a first input and a second input, the first input of the second decoder circuit to specify the number of macroblock scan lines to be decoded in parallel, the second input of the second decoder circuit to specify a second modulo value different from the first modulo value, the second decoder circuit to successively fetch second ones of the macroblock scan lines to decode based on the second modulo value, the second ones of the macroblock scan lines including the second macroblock scan line, the second ones of the macroblock scan lines different from the first ones of the macroblock scan lines.

Example 3 includes any preceding clause(s) of examples 1-2, wherein the encoded video frame includes a plurality macroblock scan lines, the load balancing algorithm is a greedy algorithm, and the first decoder circuit is to select the first macroblock scan line based on a data structure, the data structure to track decode status of the macroblock scan lines, the data structure to specify the first macroblock scan line is a next available undecoded macroblock scan line of the encoded video frame, and update the data structure after selection of the first macroblock scan line to specify the first macroblock scan line is unavailable for decoding.

Example 4 includes any preceding clause(s) of examples 1-3, wherein the second decoder circuit is to select the second macroblock scan line based on the data structure, the data structure to specify the second macroblock scan line is a next available undecoded macroblock scan line of the encoded video frame, and update the data structure after selection of the second macroblock scan line to specify the second macroblock scan line is unavailable for decoding.

Example 5 includes any preceding clause(s) of examples 1-4, wherein the first decoder circuit is to perform data fetches associated with the first macroblock scan line based on a fetch index, and reset the fetch index to an initial value based on a determination that the fetch index exceeds a size of a video bitstream associated with the encoded video frame.

Example 6 includes any preceding clause(s) of examples 1-5, wherein the first decoder circuit is to decode data associated with the first macroblock scan line into blocks of coefficients, and end decoding of one of the blocks of coefficients based on a determination that a block index of a next coefficient to be decoded exceeds a number of coefficients in the one of the blocks.

Example 7 includes any preceding clause(s) of examples 1-6, wherein the first decoder circuit is to increment the block index based on a run of zero-value coefficients indicated in the data associated with the first macroblock scan line, and determine whether incrementing the block index will cause the block index to exceed the number of coefficients in the one of the blocks.

Example 8 includes any preceding clause(s) of examples 1-7, wherein the first decoder circuit is to detect a bitstream underflow error associated with the fetch of the first macroblock scan line, and continue to decode the first macroblock scan line based on recovery data after detection of the bitstream underflow error.

Example 9 includes any preceding clause(s) of examples 1-8, wherein the first decoder circuit includes a first entropy decoder circuit to perform entropy decoding on fetched data associated with the first macroblock scan line, a first inverse quantizer and transformer circuit to perform inverse quantization and inverse transformation on output data from the first entropy decoder circuit, and a first format converter circuit to perform format conversion on output data from the first inverse quantizer and transformer circuit to determine decoded macroblocks associated with the first macroblock scan line, and the second decoder circuit includes a second entropy decoder circuit to perform entropy decoding on fetched data associated with the second macroblock scan line, a second inverse quantizer and transformer circuit to perform inverse quantization and inverse transformation on output data from the second entropy decoder circuit, and a second format converter circuit to perform format conversion on output data from the second inverse quantizer and transformer circuit to determine decoded macroblocks associated with the second macroblock scan line.

Example 10 includes any preceding clause(s) of examples 1-9, wherein the first decoder circuit includes a first alpha decode circuit to obtain decoded alpha values corresponding to the decoded macroblocks associated with the first macroblock scan line, and the second decoder circuit includes a second alpha decode circuit to obtain decoded alpha values corresponding to the decoded macroblocks associated with the second macroblock scan line.

Example 11 includes any preceding clause(s) of examples 1-10, including a workload manager circuit to configure operation of the first decoder circuit and the second decoder circuit based on a header associated with the encoded video frame.

Example 12 includes any preceding clause(s) of examples 1-11, wherein the workload manager circuit is to configure, based on the header, the first decoder circuit with a size of a bitstream associated with the encoded video frame, a number of macroblock scan lines in the encoded video frame, and a first number of macroblocks included in the first macroblock scan line, and configure, based on the header, the second decoder circuit with the size of the bitstream associated with the encoded video frame, the number of macroblock scan lines in the encoded video frame, and a second number of macroblocks included in the second macroblock scan line.

Example 13 includes a system comprising memory to store an encoded video frame, and a plurality of decoder circuits to operate in parallel to fetch macroblock scan lines of the encoded video frame from memory and decode the fetched macroblock scan lines, respective ones of the decoder circuits to fetch and decode corresponding different ones of the macroblock scan lines in parallel until the encoded video frame is decoded.

Example 14 includes any preceding clause(s) of example 13, wherein a first one of the decoder circuits includes a first input to specify a number of macroblock scan lines to be decoded by the plurality of decoder circuits in parallel, and a second input to specify a modulo value, the first one of the decoder circuits to successively fetch ones of the macroblock scan lines beginning with the modulo value and offset by multiples of the number of macroblock scan lines to be decoded in parallel.

Example 15 includes any preceding clause(s) of examples 13-14, wherein a first one of the decoder circuits is to access a data structure that is to track decode status of the macroblock scan lines, the data structure to specify a next available undecoded macroblock scan line of the encoded video frame, select the one of the macroblock scan lines that is specified by the data structure as the next available undecoded macroblock scan line, and update the data structure to specify that the selected one of the macroblock scan lines is unavailable for decoding.

Example 16 includes any preceding clause(s) of examples 13-15, wherein a first one of the decoder circuits is to perform data fetches associated with a first one of the macroblock scan lines based on a fetch index, and reset the fetch index based on a determination that the fetch index exceeds a size of a video bitstream associated with the encoded video frame.

Example 17 includes any preceding clause(s) of examples 13-16, wherein a first one of the decoder circuits is to decode data associated with a first one of the macroblock scan line into blocks of coefficients, and end decoding of one of the blocks of coefficients based on a determination that a block index of a next coefficient to be decoded exceeds a number of coefficients in the one of the blocks.

Example 18 includes any preceding clause(s) of examples 13-17, wherein a first one of the decoder circuits is to detect a bitstream underflow error associated with a fetch of a first one of the macroblock scan lines, and continue to decode the first one of the macroblock scan lines based on recovery data after detection of the bitstream underflow error.

Example 19 includes at least one non-transitory machine-readable medium comprising instructions to cause at least one programmable circuit to at least parse a header of a bitstream associated with an encoded video frame, and configure, based on the header, a plurality of decoder circuits to operate in parallel to fetch macroblock scan lines of the encoded video frame from memory and decode the fetched macroblock scan lines, respective ones of the decoder circuits to fetch and decode corresponding different ones of the macroblock scan lines in parallel until the encoded video frame is decoded.

Example 20 includes any preceding clause(s) of example 19, wherein the instructions are to cause one or more of the at least one programmable circuit to configure, based on the header, a first one of the decoder circuits with a size of a bitstream associated with the encoded video frame, a number of macroblock scan lines in the encoded video frame, and a first number of macroblocks included in a first one of the macroblock scan lines to be fetched and decoded by the first one of the decoder circuits, and configure, based on the header, a second one of the decoder circuits with the size of the bitstream associated with the encoded video frame, the number of macroblock scan lines in the encoded video frame, and a second number of macroblocks included in a second one of the macroblock scan lines to be decoded by the second one of the decoder circuits.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
a first decoder circuit to decode a first macroblock scan line of an encoded video frame, the first decoder circuit to fetch the first macroblock scan line from memory based on a load balancing algorithm; and
a second decoder circuit to decode a second macroblock scan line of the encoded video frame, the second macroblock scan line different from the first macroblock scan line, the second decoder circuit to fetch the second macroblock scan line from the memory based on the load balancing algorithm, the first decoder circuit to decode the first macroblock scan line and the second decoder circuit to decode the second macroblock scan line in parallel.

2. The apparatus of claim 1, wherein the encoded video frame includes a plurality macroblock scan lines, the load balancing algorithm is a round-robin algorithm, and:
the first decoder circuit includes a first input and a second input, the first input of the first decoder circuit to specify a number of macroblock scan lines to be decoded in parallel, the second input of the first decoder circuit to specify a first modulo value, the first decoder circuit to successively fetch first ones of the macroblock scan lines to decode based on the first modulo value, the first ones of the macroblock scan lines including the first macroblock scan line; and
the second decoder circuit includes a first input and a second input, the first input of the second decoder circuit to specify the number of macroblock scan lines to be decoded in parallel, the second input of the second decoder circuit to specify a second modulo value different from the first modulo value, the second decoder circuit to successively fetch second ones of the macroblock scan lines to decode based on the second modulo value, the second ones of the macroblock scan lines including the second macroblock scan line, the second ones of the macroblock scan lines different from the first ones of the macroblock scan lines.

3. The apparatus of claim 1, wherein the encoded video frame includes a plurality macroblock scan lines, the load balancing algorithm is a greedy algorithm, and the first decoder circuit is to:
select the first macroblock scan line based on a data structure, the data structure to track decode status of the macroblock scan lines, the data structure to specify the first macroblock scan line is a next available undecoded macroblock scan line of the encoded video frame; and
update the data structure after selection of the first macroblock scan line to specify the first macroblock scan line is unavailable for decoding.

4. The apparatus of claim 3, wherein the second decoder circuit is to:
select the second macroblock scan line based on the data structure, the data structure to specify the second macroblock scan line is a next available undecoded macroblock scan line of the encoded video frame; and
update the data structure after selection of the second macroblock scan line to specify the second macroblock scan line is unavailable for decoding.

5. The apparatus of claim 1, wherein the first decoder circuit is to:
perform data fetches associated with the first macroblock scan line based on a fetch index; and
reset the fetch index to an initial value based on a determination that the fetch index exceeds a size of a video bitstream associated with the encoded video frame.

6. The apparatus of claim 1, wherein the first decoder circuit is to:
decode data associated with the first macroblock scan line into blocks of coefficients; and
end decoding of one of the blocks of coefficients based on a determination that a block index of a next coefficient to be decoded exceeds a number of coefficients in the one of the blocks.

7. The apparatus of claim 6, wherein the first decoder circuit is to:
increment the block index based on a run of zero-value coefficients indicated in the data associated with the first macroblock scan line; and
determine whether incrementing the block index will cause the block index to exceed the number of coefficients in the one of the blocks.

8. The apparatus of claim 1, wherein the first decoder circuit is to:
detect a bitstream underflow error associated with the fetch of the first macroblock scan line; and
continue to decode the first macroblock scan line based on recovery data after detection of the bitstream underflow error.

9. The apparatus of claim 1, wherein:
the first decoder circuit includes:
a first entropy decoder circuit to perform entropy decoding on fetched data associated with the first macroblock scan line;
a first inverse quantizer and transformer circuit to perform inverse quantization and inverse transformation on output data from the first entropy decoder circuit; and
a first format converter circuit to perform format conversion on output data from the first inverse quantizer and transformer circuit to determine decoded macroblocks associated with the first macroblock scan line; and
the second decoder circuit includes:
a second entropy decoder circuit to perform entropy decoding on fetched data associated with the second macroblock scan line;
a second inverse quantizer and transformer circuit to perform inverse quantization and inverse transformation on output data from the second entropy decoder circuit; and
a second format converter circuit to perform format conversion on output data from the second inverse quantizer and transformer circuit to determine decoded macroblocks associated with the second macroblock scan line.

10. The apparatus of claim 9, wherein:
the first decoder circuit includes a first alpha decode circuit to obtain decoded alpha values corresponding to the decoded macroblocks associated with the first macroblock scan line; and
the second decoder circuit includes a second alpha decode circuit to obtain decoded alpha values corresponding to the decoded macroblocks associated with the second macroblock scan line.

11. The apparatus of claim 1, including a workload manager circuit to configure operation of the first decoder circuit and the second decoder circuit based on a header associated with the encoded video frame.

12. The apparatus of claim 11, wherein the workload manager circuit is to:
configure, based on the header, the first decoder circuit with a size of a bitstream associated with the encoded video frame, a number of macroblock scan lines in the encoded video frame, and a first number of macroblocks included in the first macroblock scan line; and
configure, based on the header, the second decoder circuit with the size of the bitstream associated with the encoded video frame, the number of macroblock scan lines in the encoded video frame, and a second number of macroblocks included in the second macroblock scan line.

13. A system comprising
memory to store an encoded video frame; and
a plurality of decoder circuits to operate in parallel to fetch macroblock scan lines of the encoded video frame from memory and decode the fetched macroblock scan lines, respective ones of the decoder circuits to fetch and decode corresponding different ones of the macroblock scan lines in parallel until the encoded video frame is decoded.

14. The system of claim 13, wherein a first one of the decoder circuits includes:
a first input to specify a number of macroblock scan lines to be decoded by the plurality of decoder circuits in parallel; and
a second input to specify a modulo value, the first one of the decoder circuits to successively fetch ones of the macroblock scan lines beginning with the modulo value and offset by multiples of the number of macroblock scan lines to be decoded in parallel.

15. The system of claim 13, wherein a first one of the decoder circuits is to:
access a data structure that is to track decode status of the macroblock scan lines, the data structure to specify a next available undecoded macroblock scan line of the encoded video frame;
select the one of the macroblock scan lines that is specified by the data structure as the next available undecoded macroblock scan line; and
update the data structure to specify that the selected one of the macroblock scan lines is unavailable for decoding.

16. The system of claim 13, wherein a first one of the decoder circuits is to:
perform data fetches associated with a first one of the macroblock scan lines based on a fetch index; and
reset the fetch index based on a determination that the fetch index exceeds a size of a video bitstream associated with the encoded video frame.

17. The system of claim 13, wherein a first one of the decoder circuits is to:
decode data associated with a first one of the macroblock scan line into blocks of coefficients; and
end decoding of one of the blocks of coefficients based on a determination that a block index of a next coefficient to be decoded exceeds a number of coefficients in the one of the blocks.

18. The system of claim 13, wherein a first one of the decoder circuits is to:
detect a bitstream underflow error associated with a fetch of a first one of the macroblock scan lines; and
continue to decode the first one of the macroblock scan lines based on recovery data after detection of the bitstream underflow error.

19. At least one non-transitory machine-readable medium comprising instructions to cause at least one programmable circuit to at least:
parse a header of a bitstream associated with an encoded video frame; and
configure, based on the header, a plurality of decoder circuits to operate in parallel to fetch macroblock scan lines of the encoded video frame from memory and decode the fetched macroblock scan lines, respective ones of the decoder circuits to fetch and decode corresponding different ones of the macroblock scan lines in parallel until the encoded video frame is decoded.

20. The at least one non-transitory machine-readable medium of claim 19, wherein the instructions are to cause one or more of the at least one programmable circuit to:
configure, based on the header, a first one of the decoder circuits with a size of a bitstream associated with the encoded video frame, a number of macroblock scan lines in the encoded video frame, and a first number of macroblocks included in a first one of the macroblock scan lines to be fetched and decoded by the first one of the decoder circuits; and
configure, based on the header, a second one of the decoder circuits with the size of the bitstream associated with the encoded video frame, the number of macroblock scan lines in the encoded video frame, and a second number of macroblocks included in a second one of the macroblock scan lines to be decoded by the second one of the decoder circuits.
